(19) United States
(12) Patent Application Publication
(10) Pub. No.: US 2015/0021899 A1
(43) Pub. Date: Jan. 22, 2015

(54) MIRRORED PRACTICE NOTEBOOK

(71) Applicant: Rita Coore-Widener, Spring, TX (US)

(72) Inventor: Rita Coore-Widener, Spring, TX (US)

(21) Appl. No.: 14/507,817

(22) Filed: Oct. 6, 2014

Related U.S. Application Data
(63) Continuation-in-part of application No. 13/021,338, filed on Feb. 4, 2011, now abandoned.

(51) Int. Cl. B42D 3/12; G02B 7/182

(52) U.S. Cl. CPC B42D 3/12; G02B 7/182
USPC 281/29

(57) ABSTRACT

The invention describes a portfolio, presentation folder, music folder or the like including one or more mirrors to permit the user to practice playing a musical instrument, singing or delivering other oral presentation while observing the mirror(s). The mirrored portfolio provides a folio with front and back covers attached together by a spine. One or more mirrors are positioned on the insides of the front or back covers in either a removably attached, hingedly attached or fixedly attached manner. In one embodiment, a primary mirror is attached to the inside of the front cover in a fixed position while a secondary mirror, such as a removable, magnetically positionable mirror insert, is positioned on the inside face of the front cover in hinged manner at desired locations to permit it to swing outwardly from the folio to a desired angle. The folio may include pockets, pencil holders, handles, and closures.

### CROSS-REFERENCE TO RELATED APPLICATIONS

This application is a continuation in part of copending U.S. application Ser. No. 13/021,338, filed Feb. 4, 2011. The patent application identified above is incorporated herein by reference in its entirety to provide continuity of disclosure.

### STATEMENT REGARDING FEDERALLY SPONSORED RESEARCH OR DEVELOPMENT

Not Applicable.

### BACKGROUND OF THE INVENTION

The present disclosure is generally directed to practice mirrors used to assist a musician in practicing technique or to assist a person in preparing for a presentation or other type of speech. More specifically, the current disclosure is directed to mirrored practice notebooks that can be placed on a music stand, podium or other surface.

### BACKGROUND TECHNOLOGY

U.S. Pat. No. 4,934,584 (Jun. 19, 1990, Wyant), discloses a portfolio or binder comprising a front cover having a cut-out section, a rear cover hingedly connected to the front cover, and a flexible sheet having a reflective surface, the sheet being attached to the front cover such that the reflective surface is displayed outwardly through the cut-out section to define a mirror. The portfolio or binder also comprises short inner pocket panels. The portfolio, with its mirrorized cover, permits students to monitor their personal appearance during the school day without having to carry a separate hand mirror.

U.S. Pat. No. 4,637,631 (Jan. 20, 1987, Baer) and U.S. Pat. No. 4,743,047 (May 10, 1988, Baer), which is a continuation-in-part of Baer U.S. Pat. No. 4,637,631, together disclose a book in combination with a mirror. A book such as one might ordinarily keep on one's shelf has a mirror embedded in one of the bound sections such that upon picking up the book and leafing through several pages, one is confronted with one's reflection. This allows for an added dimension to communication. The mirror is embedded in a thick section, the leaves of which may be bound and laminated together, a hole corresponding in dimensions to the mirror is cut partially therethrough, a mirror is immovably placed in said hole. In one embodiment, the mirror is mounted in countersunk fashion in the back cover with mounting means. In another embodiment, a reflective surface of the mirror is flush with the inner surface of the cover. In another embodiment, the mirror is embedded into a rather thick page wherein is embedded a mirror that would reflect the reader's face when the reader opens the book to that page thereby serving as a means for conveying nonverbal communication within a verbal communication media. The identity of the reader (via the mirrored reflection of the reader's face) may be intended to coincide with the identity of a person to whom the book is dedicated.

U.S. Pat. No. 1,804,487 (May 12, 1931, Yoshioka) discloses a mirror removably mounted on the inner surface of the cover of a book to serve as an agent through means of which one's personal appearance may be indicated. The mirror may be readily removed from place for the purposes of replacement or substitution.

U.S. Pat. No. 6,851,825 (Feb. 8, 2005, Marshall) discloses an attachable book mirror device that enables the reader of a textual document to view the facial expressions of the young adult, child, toddler, or baby who is listening in close proximity to the reader. The listener can also view the mechanical lip movements of the reader to thereby shorten process of learning to read. The attachable book mirror includes a shell for housing the optically human visual spectrum reflective material that is pivotally connected to a base used to attach to the covers of books or any other suitable document. The reflective material can be adjusted in any allowable position, holding its last position due to certain equal but opposite forces that are generated by certain internal components such as a spring contained within the base that helps create a lasting static contact frictional force. An adjustable light may be pivotally attached to the book mirror.

U.S. Pat. No. 6,962,421 (Nov. 8, 2005, Yang) discloses a folding full length mirror and carry apparatus that includes a foldable reflective surface support assembly which includes support panels connected together with panel interconnection hinges. A non-folded reflective surface assembly is supported by the foldable reflective surface support assembly. Preferably, a handle is connected to the foldable reflective surface support assembly. A shoulder strap can be connected to the foldable reflective surface support assembly. Preferably, a folded condition locking assembly is connected to the foldable reflective surface support assembly for retaining the apparatus in a folded up, carrying condition. With one embodiment of the invention, the non-folded reflective surface assembly includes panel mounted non-folded reflective surfaces mounted one side of each of the respective support panels. With another embodiment of the invention, the reflective surface assembly includes a reflective rollable non-folded sheet wound on a roller assembly supported by the foldable reflective surface support assembly.

U.S. Pat. No. 5,174,576 (Dec. 29, 1992, Lee et al) discloses a portable mirror apparatus for a golfer to view his swing which has a U-shaped hollow tubular frame with cross in between, also divided in the middle and a mirror attached on the front. A pair of retracting legs support the invention in the vertical position each having a support bar for stiffening. The invention folds in the middle for transportation and storage with the legs pivoted inward contiguous with the frame. The mirror contains marks in the form of lines both horizontal and vertical to indicate proper alignment of the golfer during the swing of a golf club. The mirror is thermoplastic for strength and durability, also to reduce weight. The mirror is constructed of a sturdy and durable thermoplastic material, such as acrylic, that may be transported and set up without the fear of breakage and the dangers involved with conventional glass mirrors.

Similarly, U.S. Pat. No. 5,270,871 (Dec. 14, 1993, Florian) provides for an athletic skill practice mirror which is light weight and relatively portable. The mirror can have an alignment image whereby a participant can stand in front of the practice mirror and compare his reflective image with that of the alignment image to detect and correct improper body alignment.

USD407452 (Mar. 30, 1999, Porter) provides an ornamental design for a golf putter head with a removable practice mirror.

U.S. Pat. No. 6,626,675 (Sep. 30, 2003, Webber) discloses a multiple activity apparatus is for educational, therapeutic, or recreational use comprising three rectangular frame members joined at abutting ends in a triangular configuration having open triangular ends. The triangular configuration has a base and upwardly converging sides with a utility board mounted in each respective frame member. Each board has an exterior work surface so that a pair of upright work surfaces are selectively positionable for use at any one time. A method of utilizing visual teaching aids comprises the steps of assembling three utility panels each having a side surface useful as a teaching aid; disconnectably joining each of the three panels in juxtaposition forming at least two junctures between panels with the exterior surfaces positioned at an angle for use as teaching aids; and stacking the three boards generally fiat forming an assembly for transport. The exterior surfaces may include a mirror, a wipe on-off dual function and magnetic board, and a pocket board. The mirror activity panel is used so that the student may watch the muscle movements of the articular muscles of his mouth. By watching the muscle movements of the mouth, the student can see how the mouth is shaped in order to pronounce the correct sounds. In this manner, by practice, the student can learn proper articulation of sounds and words.

U.S. Pat. No. 6,267,413 (Jul. 31, 2001, Tran) discloses a double album of photograph display that includes two mirror image portions located on opposite sides of a central web. Each mirror image portion is formed with a stiff, rectangular outer cover panel, an intermediate end panel, and a stiff inner cover panel. A packet of photograph mounting sheets is secured to the inside surface of the end panel of each mirror image portion of the base structure. Each of the photograph mounting sheets is capable of mounting at least one photograph. Preferably, pockets are provided in each photograph mounting sheet to accommodate a plurality of photographs in each mounting sheet. Photograph viewing windows are formed through the inner cover panels. Mutually engageable fasteners, such as spring ties, on each side of the central web may be provided to hold each packet within the confines of its associated outer and inner cover panel and the end panel to which the packet is secured. The album may be used as a freestanding structure whereby photographs in the viewing windows of the inner cover panels are displayed much in the manner of a freestanding frame for a plurality of photographs. When the fasteners are disengaged, the photograph mounting pages within both packets are accessible for viewing concurrently. The album may also be completely folded into a compact, generally rectangular book-like structure and stored in a book case, if desired.

U.S. Pat. No. 470,861 (Mar. 15, 1892, Chichester) discloses a book having a double-sided slate surface removably mounted on the inside of one or both of the book's covers. The slate is preferably of flexible material, such as paper, with one or both surfaces covered with a silicate slate or similar preparation that produces a surface adapted to the reception of pencil marks. The slate is removable for cleaning.

US20090140511 (Jun. 4, 2009, Pestl) discloses an album for photographs and similar collectable items that comprises a set of one or more straps extending from the album and arranged to either wrap around the edges of the album to hold it closed, or to provide stability to the album when it is opened in an easel configuration for display of the album contents.

U.S. Pat. No. 4,703,952 (Nov. 3, 1987, Biasini) discloses a folder of the type used for carrying sheets of material and being adaptable for displaying the sheets, being provided with a folder having a pair of panels joining together and being foldable at a center of the folder. Each panel has a pocket portion for storing the sheets of material and a foldable ledge means for displaying the sheets when the folder is in an open position. The folder is also provided with bands for supporting the folder on the hand of a user and means for displaying the folder in an open position on substantially flat surfaces.

U.S. Pat. No. 5,356,109 (Oct. 18, 1994, Biasini) discloses a music stand extender adapted to be mounted to a conventional music stand in a manner to present an expanded support area. This extender comprises, in a preferred form, three panel sections which in an expanded position rest against a back portion of the music stand, and three flange sections that are positioned on a lower ledge portion of the stand. The extender can be folded over on itself to function as a sheet music container and carrier, and can be extended to its support position to be placed on a music stand. In one embodiment there is provided a strap which extends along the upper back portion of the panel sections for use in securing the extender to the music stand. In another embodiment, a retaining sheet or pocket section extends along the back top edge of the extender capable of being slipped over the top of the music stand sheet support section to secure the extender to the music stand.

US20050012014 (Jan. 20, 2005, Willner et al) discloses a music-stand-fitting removable sleeve or clipped-on device that fits over a music stand, of the type used to display sheet music for a musician, which performs the purpose of holding music, books, papers, or writing implements via additional securing devices and pockets. The Sheet Music Stand Helper is a removable sleeve or clipped-on device which fits over the top of a music stand, which has one or more pockets in the back for holding sheet music and/or writing implements, transparent pockets in the front, for holding viewable sheet music, and a vertical strap in the middle to secure music to the Sheet Music Stand Helper, with fabric under the strap to muffle snapping sound should the securing strap be snapped.

U.S. Pat. No. 4,512,603 (Apr. 23, 1985, Williams) discloses a book support system that employs an elastic cord to secure the book to the support system.

US20090189388 (Jul. 30, 2009, Mills) discloses an adjustable book holder device that employs an elastic band extending from one side to the other to exert a slight pressure on the open book pages to keep the book in the open position while resting on the support plate. A relatively thin cord or strap may be used for the elastic band, and if a strap is used, the strap may be transparent. A flexible chain may be adjusted to alter the inclination of the support plate with respect to a rear brace.

However, there still exists a need to provide a mirrored portfolio, for holding music, notes, and the like, to permit a musician, singer, presenter, etc. to have portable mirrors provided in the same carrying case to provide for an enhanced mode of practicing such music, singing, or presentation.

### SUMMARY OF THE INVENTION

The invention describes a portfolio, presentation folder, music folder or the like including one or more mirrors to permit the user to practice playing a musical instrument, singing or delivering other oral presentation while observing himself/herself in the mirror(s). The mirrored portfolio provides a folio with front and back covers attached together by a spine. One or more mirrors are positioned on the insides of the front or back covers in either a removably attached, hingedly attached or fixedly attached manner. In one embodiment, a primary mirror is attached to the inside of the back cover in a fixed position while a secondary mirror is positioned on the inside face of the front cover in hinged manner at its outer edge to permit it to swing outwardly from the folio to a desired angle. The folio may include one or more internal or external pockets for holding music, papers and the like.

The present disclosure describes a notebook (which may be padded) having two mirrors (one or both may be hinged). The notebook is to be used as a practice tool for speakers, musicians, etc., and may be attached to a music stand or podium, and may include straps for securing it.

The mirrored portfolio of the present invention includes a conveniently sized, portable mirror for use on any music stand or podium. In one embodiment, the invention is used as a practice tool for student and professional musicians. The invention may also be useful to public speakers as a practice tool. It is suitable for use at home, classroom settings, and discreet enough to be used during performance or live presentation if needed. The design is compact (fitting within a standard music folder, or presentation folio, etc.) and therefore is readily portable and stores easily.

One embodiment of the present invention features a padded notebook. The notebook works as a frame for the mirror and carrying case when folded. In one embodiment, the notebook has the following dimensions when folded: Width 9.25 in.×Length 12.5 in.×Depth 0.75 in. The notebook may be outfitted with hook and loop fasteners, such as the Velcro brand on the outside of the notebook used to secure the two sides of the notebook together when used in a configuration requiring the front and back cover panels to be opened fully in a back to back manner. The notebook ideally employs a large flat mirror to service as the primary reflective surface. In the above-dimensioned notebook, ideal mirror dimensions are: Length 10 in.×Width 8 in. This large, flat mirror is attached to one of the inner covers of the notebook. A second, hinged mirror is the secondary reflective surface and provides an extended view as it may be opened into extended configurations. The mirror angle can be adjusted with the hinge and the mirror folds flat onto the inside cover for storage. One suitable set of dimensions for the secondary mirror is: Length 8 in.×Width 5 in. The hinged mirror is ideally attached to the inside of the other cover, about 0.5 in. from the edge of the notebook and is ideally centered along the length of notebook cover. A protective cloth cover is provided for the large mirror to help prevent scratching during storage. Buttons (or other fasteners) attached to notebook provide anchor for elastic security straps that can be used to keep the notebook in its closed position, or to assist in securing it into an open position on a music stand or podium. The elastic can be used to secure the mirrored notebook to the music stand to help prevent it from falling off during use. Also, the elastic may be used to keep the notebook closed during storage or travel. The elastic attached to the bottom right corner of the inside folder cover is approximately 17.25 in. The elastic attached to the inside at the center of right side of notebook is approximately 10.5 in. Other dimensions are possible. The notebook ideally contains a pocket on the side of the notebook used for storing sheet music or other papers. In use, the notebook can be turned upside down so that the flat mirror can be on the left and the hinged mirror on the right during use. Buttons or other attachment devices can be used to anchor the elastic closures (much like the button/elastic closures used on envelopes and folders. However, the elastic could be attached directly to the cover, e.g., by sewing thereby eliminating the need for buttons.

In one embodiment of the present disclosure there is disclosed and described a portable mirrored practice notebook comprising: (a) a front cover having a front cover inside face, a front cover outside face, a front cover top edge, a front cover bottom edge opposite the front cover top edge, a front cover outside edge, and a front cover inside edge opposite the front cover outside edge; (b) a back cover having a back cover inside face, a back cover outside face, a back cover top edge, a back cover bottom edge opposite the back cover top edge, a back cover outside edge, and a back cover inside edge opposite the back cover outside edge; (c) a flexible spine hingedly connecting the front cover inside edge to the back cover inside edge to permit the front cover and back cover to open and close about the hinged connection along a desired spine angle; (d) a first mirror attached to the back cover inside face, the first mirror having a front surface, a rear surface, a top edge, a bottom edge opposite the top edge, an inside edge and an outside edge opposite the inside edge; (e) a second mirror attached to the front cover inside face, the second mirror having a front surface, a rear surface, a top edge, a bottom edge opposite the top edge, an inside edge and an outside edge opposite the inside edge, wherein the second mirror inside edge is hingably attached to the front cover inside face proximate the front cover outside edge to permit the second mirror to be adjustably rotated about the hinged attachment between a closed position and an open position, the closed position being defined as where the second mirror front surface rests against the front cover inside face, the open position being defined as where the second mirror front surface is rotated away from the front cover inside face to a desired second mirror angle; and (f) at least one pocket to receive notepapers, sheet music, or the like.

In one embodiment, the front surface of the first mirror contains a reflective mirror finish and the rear surface of the first mirror is mounted to the back cover inside face using glue, adhesives, double sided adhesive tape, clips, fasteners, hook and loop fasteners, magnetic mounts, hinges or the like.

In another embodiment, the first mirror inside edge is hingably attached to the back cover inside face proximate the back cover inside edge to permit the first mirror to be rotated about its hinge. The front surface and/or rear surface of the first mirror contains a reflective mirror finish. In one embodiment, the first mirror outside edge is hingably attached to the back cover inside face proximate the back cover outside edge to permit the first mirror to be rotated about its hinge. In another embodiment, the first mirror top edge is hingably attached to the back cover inside face proximate the back cover top edge to permit the first mirror to be rotated about its hinge.

The back cover inside face may contain a recessed area for receiving the first mirror. The first mirror may cover a substantial portion of the back cover inside face. A flexible protective material may be provided for covering the first mirror, the flexible material being attached to the back cover inside face to permit the protective material to cover the mirror when the mirror is not in use and to be pulled back to expose the mirror when the mirror is to be used. The flexible protective material may be selected from the group consisting of: synthetic cloth, natural cloth, flannel cloth, synthetic and natural cloth blends, soft suede-like material, plastic sheet material, rubber sheet material, and the like.

The second mirror angle may range between about 0° and 180°. The second mirror front surface and/or rear surface contains a reflective mirror finish. The front cover inside face may also include a recessed area for receiving the second mirror when the second mirror is in its closed position.

The notebook might also employ a padded layer between the front cover inside face and the front cover outside face and a padded layer between the back cover inside face and the back cover outside face. The spine angle may be adjustable between about 0° and about 360°. The notebook preferably contains at least one pocket built into the front or back cover inside face. The notebook may also employ one or more closure devices for securing the front cover to the back cover when the spine angle is either about 0° (where the front cover inside face faces the back cover inside face) and 360° (where the front cover outside face faces the back cover outside face). The closure devices may be selected from the group consisting of hook and loop fasteners, clasp closures, snap closures, magnet closures, ties, ribbons, straps, elastic loops, elastic ties, buttons, zippers, belt with fastener, buckles, loop and belt strap enclosures, belt and buckle enclosures, belt and snap enclosures, and the like. The notebook may also further comprise one or more attachment devices for securing the portfolio practice mirror to a stand, the one or more attachment devices being selected from the group consisting of ties, fasteners, hook and loop fasteners, straps, elastic loops, button fasteners, clips and the like.

In another embodiment of the present invention, there is disclosed a portable mirrored practice portfolio comprising: (a) a padded front cover having an front cover inside face, a front cover outside face, a front cover top edge, a front cover bottom edge opposite the front cover top edge, a front cover outside edge, and a front cover inside edge opposite the front cover outside edge; (b) a padded back cover having an back cover inside face, a back cover outside face, a back cover top edge, a back cover bottom edge opposite the back cover top edge, a back cover outside edge, and a back cover inside edge opposite the back cover outside edge; (c) a flexible spine hingedly connecting the front cover inside edge to the back cover inside edge to permit the front cover and back cover to open and close about the hinged connection along a desired spine angle; (d) a first mirror fixedly attached to the back cover inside face, the first mirror having a front mirrored finish surface, a rear surface attached to the back cover inside face, a top edge, a bottom edge opposite the top edge, an inside edge and an outside edge opposite the inside edge, wherein the rear surface of the first mirror is attached to the back cover inside face using glue, adhesives, double sided adhesive tape, clips, fasteners, hook and loop fasteners, magnetic mounts, hinges or the like; (e) a second mirror attached to the front cover inside face, the second mirror having a front mirrored finish surface, a rear surface, a top edge, a bottom edge opposite the top edge, an inside edge and an outside edge opposite the inside edge, wherein the second mirror inside edge is hingably attached to the front cover inside face proximate the front cover outside edge to permit the second mirror to be rotated about the hinged attachment between a closed position and an open position, the closed position being defined as where the second mirror front surface rests against the front cover inside face, the open position being defined as where the second mirror front surface is rotated away from the front cover inside face to a desired second mirror angle; (f) a flexible protective material for covering the first mirror, the flexible material having a top edge, bottom edge, right side edge and left side edge, the flexible material being attached to the back cover inside face to permit the protective material to cover the mirror when the mirror is not in use and to be pulled back to expose the mirror when the mirror is to be used, wherein one edge of the flexible protective material is mounted proximate to a corresponding edge of the first mirror, wherein the flexible protective material is selected from the group consisting of: synthetic cloth, natural cloth, synthetic and natural cloth blends, plastic sheet material, rubber sheet material and the like; (g) one or more pockets located within the front cover inside face and/or the back cover inside face capable of receiving notepapers, sheet music, and the like; and (h) one or more elastic loops attachable proximate to the outer edges of the front cover outside edge and/or the back cover outside edge for securing the portfolio into a closed position or to secure the portfolio to a stand upon which the portfolio is placed.

Another embodiment of the present invention describes a portable mirrored practice folio comprising: (a) a front cover having an front cover inside face, a front cover outside face, a front cover top edge, a front cover bottom edge opposite the front cover top edge, a front cover outside edge, and a front cover inside edge opposite the front cover outside edge; (b) a back cover having an back cover inside face, a back cover outside face, a back cover top edge, a back cover bottom edge opposite the back cover top edge, a back cover outside edge, and a back cover inside edge opposite the back cover outside edge; (c) a flexible spine hingedly connecting the front cover inside edge to the back cover inside edge to permit the front cover and back cover to open and close about the hinged connection along a desired spine angle; (d) a primary mirror fixedly attached to the back cover inside face, the primary mirror having a front mirrored finish surface, a rear surface, a top edge, a bottom edge opposite the top edge, an inside edge and an outside edge opposite the inside edge, wherein the primary mirror inside edge is hingably attached to the back cover inside face proximate the back cover inside edge to permit the primary mirror to be rotated about its hinge; (e) a secondary mirror attached to the front cover inside face, the secondary mirror having a front mirrored finish surface, a rear surface, a top edge, a bottom edge opposite the top edge, an inside edge and an outside edge opposite the inside edge, wherein the second mirror inside edge is hingably attached to the front cover inside face proximate the front cover outside edge to permit the secondary mirror to be rotated about the hinged attachment between a closed position and an open position, the closed position being defined as where the secondary mirror front surface rests against the front cover inside face, the open position being defined as where the secondary mirror front surface is rotated away from the front cover inside face to a desired second mirror angle; (f) a flexible protective material for covering the primary mirror, the flexible material having a top edge, bottom edge, right side edge and left side edge, the flexible material being attached to the back cover inside face to permit the protective material to cover the primary mirror when the mirror is not in use and to be pulled back to expose the mirror when the mirror is to be used, wherein one edge of the flexible protective material is mounted proximate to a corresponding edge of the primary mirror, wherein the flexible protective material is selected from the group consisting of: synthetic cloth, natural cloth, synthetic and natural cloth blends, plastic sheet material, rubber sheet material and the like; (g) one or more pockets located within the front cover inside face and/or the back cover inside face capable of receiving notepapers, sheet music, and the like; (h) one or more closure devices for securing the front cover to the back cover when the spine angle is either about 0° (where the front cover inside face faces the back cover inside face) and 360° (where the front cover outside face faces the back cover outside face), the closure devices being selected from the group consisting of hook and loop fasteners, clasp closures, snap closures, magnet closures, ties, ribbons, straps, elastic loops, elastic ties, buttons, zippers, belt with fastener, buckles, loop and belt strap enclosures, belt and buckle enclosures, belt and snap enclosures, and the like; and (h) one or more attachment devices attachable proximate to the outer edges of the front cover outside edge and/or the back cover outside edge for securing the portfolio into a closed position or to secure the portfolio to a stand upon which the portfolio is placed, the one or more attachment devices being selected from the group consisting of ties, fasteners, hook and loop fasteners, straps, elastic loops, button fasteners, clips, and the like.

Another embodiment of the present invention describes a portable mirrored practice notebook comprising: (a) a front cover having a front cover inside face, a front cover outside face, a front cover top edge, a front cover bottom edge opposite the front cover top edge, a front cover outside edge, and a front cover inside edge opposite the front cover outside edge; (b) a back cover having a back cover inside face, a back cover outside face, a back cover top edge, a back cover bottom edge opposite the back cover top edge, a back cover outside edge, a back cover inside edge opposite the back cover outside edge; (c) a flexible spine hingedly connecting the front cover inside edge to the back cover inside edge to permit the front cover and back cover to open and close about the hinged connection along a desired spine angle; (d) a first mirror attached to the front cover inside face, the first mirror having a front surface, a rear surface, a top edge, a bottom edge opposite the top edge, an inside edge and an outside edge opposite the inside edge; (e) an internal space behind the back cover inside face; (f) one or more slits, having a desired slit length, in the back cover inside face for accessing the internal space behind the back cover inside face; and a removable mirrored portfolio insert,

The removable mirrored portfolio insert comprises: (i) an insert front cover having an insert front cover inside face, an insert front cover outside face, an insert front cover top edge, an insert front cover bottom edge opposite the inset front cover top edge, an insert front cover outside edge, and an insert front cover inside edge opposite the insert front cover outside edge; (ii) an insert back cover having an insert back cover inside face, an insert back cover outside face, an insert back cover top edge, an insert back cover bottom edge opposite the insert back cover top edge, an insert back cover outside edge, and an insert back cover inside edge opposite the insert back cover outside edge; (iii) an insert flexible spine hingedly connecting the insert front cover inside edge to the insert back cover inside edge to permit the insert front cover and insert back cover to open and close about the hinged connection along a desired insert spine angle; and (iv) a mirror or mirrored surface in the back cover inside face. The insert front cover is capable of being inserted into the one or more slits in the back cover inside face and into the internal space to removably attach the mirrored portfolio insert to the practice notebook.

In one embodiment, the one or more slits comprises a single slit located parallel to and proximate the back cover top edge. In another embodiment, the one or more slits comprises a single slit located parallel to and proximate the back cover bottom edge. In yet another embodiment, the one or more slits comprises a single slit located parallel to and proximate the back cover outside edge. In one embodiment, the one or more slits comprise a first slit located parallel to and proximate the back cover top edge, a second slit located parallel to and proximate the back cover bottom edge, and a third slit located parallel to and proximate the back cover outside edge.

The notebook can further comprise one or more first magnets embedded within the back cover, the first magnets having a first polarity directed toward the back cover inside face, and one or more second magnets embedded within the insert front cover, the second magnets oriented to direct a second polarity opposite the first polarity to cause the one or more second magnets to be attracted to the one or more first magnets when the insert front cover is inserted into the internal space through one of the one or more slits.

The notebook of this embodiment can also further comprising a flexible protective material for covering the first mirror, as described herein.

In one embodiment, a removable insertable clip is provided capable of being inserted into and removed from the insert flexible spine to assist in maintaining a desired angle of openness between the insert front and back faces when in use in the notebook, the insert flexible spine further comprising an opening for receiving the clip. The notebook may also contain one or more loops attached to the notebook for holding pencils or pens. The notebook may also contain a closure device for securing the notebook front cover to the notebook back cover.

Also described herein is a portable mirrored practice notebook comprising a front cover; a back cover; a flexible spine connecting the front and back covers; a first mirror attached to the inside of the inside face of the front cover; an internal space behind the back cover inside face; one or more slits, having a desired slit length, in the back cover inside face for accessing the internal space behind the back cover inside face; a removable mirrored portfolio insert. The mirrored insert comprises an insert front cover, an insert back cover, an insert flexible spine connecting the front and back covers, and a mirror or mirrored surface on the inside face of the insert back cover, the insert front cover capable of being inserted into the one or more slits in the back cover inside face and into the internal space to removably attach the mirrored portfolio insert to the practice notebook; and one or more first magnets embedded within the back cover, the first magnets having a first polarity directed toward the back cover inside face, and one or more second magnets embedded within the insert front cover, the second magnets oriented to direct a second polarity opposite the first polarity to cause the one or more second magnets to be attracted to the one or more first magnets when the insert front cover is inserted into the internal space through one of the one or more slits. In one embodiment, the one or more slits comprises a first slit located parallel to and proximate the back cover top edge, a second slit located parallel to and proximate the back cover bottom edge, and a third slit located parallel to and proximate the back cover outside edge. This embodiment may further comprise a flexible protective material for covering the first mirror.

A removable insertable clip is also provided capable of being inserted into and removed from the insert flexible spine to assist in maintaining a desired angle of openness between the insert front and back faces when in use in the notebook. As with other embodiments, this embodiment can also further comprise one or more loops attached to the notebook for holding pencils or pens and/or a closure device for securing the notebook front cover to the notebook back cover.

### BRIEF DESCRIPTION OF THE DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1A shows an embodiment of the mirrored portfolio in an open position with a left hinged mirror extended and a right fixed mirror exposed (cloth cover pulled back). A small pocket is shown on the left inside cover.

FIG. 1B shows a cross section of the right side cover of the portfolio of FIG. 1A taken along lines 1B-1B depicting an embodiment where the right fixed mirror is mounted on top of the surface of the right inside cover.

FIG. 1C shows a cross section of the right side cover of the portfolio of FIG. 1A taken along lines 1C-1C depicting another embodiment where the right fixed mirror is mounted recessed into the inside right cover.

FIG. 1D shows an embodiment of the mirrored practice notebook displayed in open position on a stand (depicted here in broken lines as, for example, a music stand).

FIG. 2A shows an embodiment of the mirrored portfolio in an open position with the left hinged mirror extension shown in the closed position (the back side of the left mirror is preferably non-reflective, but could be mirrored if desired). The right mirror is shown covered with a protective cover, such as a cloth. A small pocket is shown on the left inside cover.

FIG. 2B shows a cross section of the left side cover of the portfolio of FIG. 2A taken along lines 2B-2B in an embodiment where the left hinged mirror is mounted on the top surface of the left inside cover.

FIG. 2C shows a cross section of the left side cover of the portfolio of FIG. 2A taken along lines 2C-2C in an embodiment where the left hinged mirror is mounted recessed into the left inside cover.

FIG. 3 illustrates an embodiment of the mirrored practice notebook in an open position with the left hinged mirror extended and a hinged right mirror extended in a hinged configuration (cloth not shown). Pockets are shown on the left and right inside covers. Both mirrors are hinged along their respective outer edges to permit the mirrors to open outwardly.

FIG. 4 shows an embodiment of the mirrored portfolio in an open position with the left and right hinged mirrors in their closed positions. In this embodiment, the right mirror is hinged along its top edge to permit the mirror to swing upwardly. A large pocket is shown on the left inside cover.

FIG. 5A shows an embodiment of the mirrored portfolio in an open position with the left and right hinged mirrors in their closed positions. In this embodiment, the right mirror is hinged along its left edge along the inside spine of the portfolio, and is shown with a cloth cover over its surface. A large pocket is shown on the left inside cover.

FIG. 5B shows a perspective view from the back side of an embodiment of the notebook where the notebook is in a partially opened position.

FIG. 5C shows an embodiment of the notebook of FIG. 5A where the notebook is fully opened back on itself (outside cover to outside cover) displaying the large mirror (with its protective cover pulled back).

FIG. 5D illustrates an embodiment of the notebook of FIG. 5A shown in perspective view where the notebook is fully opened back on itself (outside cover to outside cover) displaying the large mirror (with the protective cover pulled back). This embodiment also illustrates that the angle of the mirror can be adjusted to suit the user.

FIG. 5E illustrates an embodiment of the notebook of FIG. 5A shown in perspective view where the notebook is fully opened back on itself (outside cover to outside cover) displaying the large mirror (with the cloth cover pulled back). The notebook is shown in use on a stand (depicted here in broken lines as, for example, a music stand). This embodiment also illustrates that the angle of the mirror can be adjusted to suit the user, particularly where the angle of the stand is not adjustable.

FIG. 6 illustrates an embodiment of the mirrored portfolio shown secured in a closed position.

FIG. 7A shows another embodiment of the mirrored portfolio in an open position with a fixed mirror attached to the left inside portfolio cover, but shown covered with cloth or flexible cover. The right inside portfolio cover contains one or more internal magnets, and a series of mirror position slits are shown on the right inside portfolio cover to accommodate different mirror mounting positions.

FIG. 7B shows the embodiment of FIG. 7A except with the mirror cover removed to expose the mirror for use.

FIG. 8A shows a perspective view of a removable mirrored portfolio insert shown in the open position with a fixed mirror attached to the right inside cover. The left cover is capable of being inserted into any of the slits in the portfolio of, e.g., FIG. 7A, and may contain a magnet to assist in securing it in place within the slit.

FIG. 8B shows the removable mirrored insert of FIG. 8A fully opened to show the inside.

FIG. 8C is a perspective view of the back side of the removable mirrored insert shown in FIG. 8A.

FIG. 9A shows the embodiment of FIG. 7A wherein the mirrored portfolio insert of FIGS. 8A-8C is illustrated inserted into a horizontal slit located near the top edge of the inside right cover of the portfolio, the mirrored insert being further shown in a closed position.

FIG. 9B shows the embodiment of FIG. 7A wherein the mirrored portfolio insert of FIGS. 8A-8C is illustrated inserted into a vertical slit located near the right edge of the inside right cover of the portfolio, the mirrored insert being further shown in a closed position.

FIG. 9C shows the embodiment of FIG. 7A wherein the mirrored portfolio insert of FIGS. 8A-8C is illustrated inserted into a horizontal slit located near the bottom edge of the inside right cover of the portfolio, the mirrored insert being further shown in a closed position.

FIG. 9D shows the embodiment of FIG. 9B wherein the mirrored portfolio insert is illustrated in an open position.

FIG. 9E shows the embodiment of FIG. 9D wherein the cover is removed to expose the fixed mirror on the left inside cover of the portfolio.

FIG. 10A is a perspective view of the portfolio of, e.g., FIG. 1A, wherein it is partially folded back at its spine to bring the front and back outside covers together.

FIG. 10B is a perspective view of the portfolio of, e.g., FIGS. 1A and 10A, wherein it is fully folded back at its spine to bring the front and back outside covers into contact with each other.

FIG. 10C shows another embodiment of the mirrored portfolio using an elastic strap to secure into place the opposed or closed front and back covers of the embodiment of FIG. 10B.

FIG. 11 shows a spring-like clip that can be used to assist in positioning the opened mirror of the insertable mirrored portfolio insert.

FIG. 12A shows the embodiment of FIG. 9B modified to employ the clip of FIG. 11 in connection with operation of the mirrored portfolio insert.

FIG. 12B shows and end view of the right side edge of the portfolio of FIG. 12A wherein the removable mirrored portfolio insert is depicted in an open position employing the clip of FIG. 11 to assist in positioning.

FIG. 13A depicts the portfolio of FIG. 9A with the mirror cover removed to expose the left mirror, and the insertable mirrored portfolio closed to conceal its mirror.

FIG. 13B depicts the portfolio of FIG. 9B wherein the entire portfolio is flipped 180 degrees to place the fixed mirror on the right side and the insertable mirrored portfolio on the left side.

FIG. 14 illustrates the portfolio of, e.g., FIG. 9A with the portfolio folded back, front cover to back cover as in FIG. 10B, and employing an insertable mirrored portfolio inserted into the rightmost slit.

FIG. 15 depicts the portfolio of, e.g., FIG. 9A with the portfolio folded back, front cover to back cover as in FIG. 10B and displaying the fixed mirror (with cover removed).

FIG. 16 depicts an exemplary pencil or pen holder that can be employed within the portfolio embodiments.

FIG. 17 illustrates another embodiment of the mirrored portfolio using retractable carrying handles on the outside of the portfolio, shown here in the closed position.

FIG. 18 illustrates the embodiment of FIG. 17 wherein the retractable carrying handles are shown in the open position.

FIG. 19 illustrates another embodiment of the present portfolio of, e.g., FIG. 7A, that includes use of magnetic snap enclosures on the inside corners to secure the portfolio in a closed position, and also employing a pencil/pen holder (like as illustrated in FIG. 16).

FIG. 20 illustrates the embodiment of FIG. 19 wherein the mirror cover is removed to expose the fixed mirror on left side for use, and an insertable mirrored portfolio is inserted into the slit proximate the outer right edge. In this embodiment, the pencil holder can also serve as a stop for positioning the opened inserted mirror.

It will be appreciated that the foregoing drawings illustrate only certain embodiments of the invention and that numerous other variations may be created within the scope of the described invention.

### DETAILED DESCRIPTION

The above general description and the following detailed description are merely illustrative of the subject invention and additional modes, advantages and particulars of this invention will be readily suggested to those skilled in the art without departing from the spirit and scope of the invention.

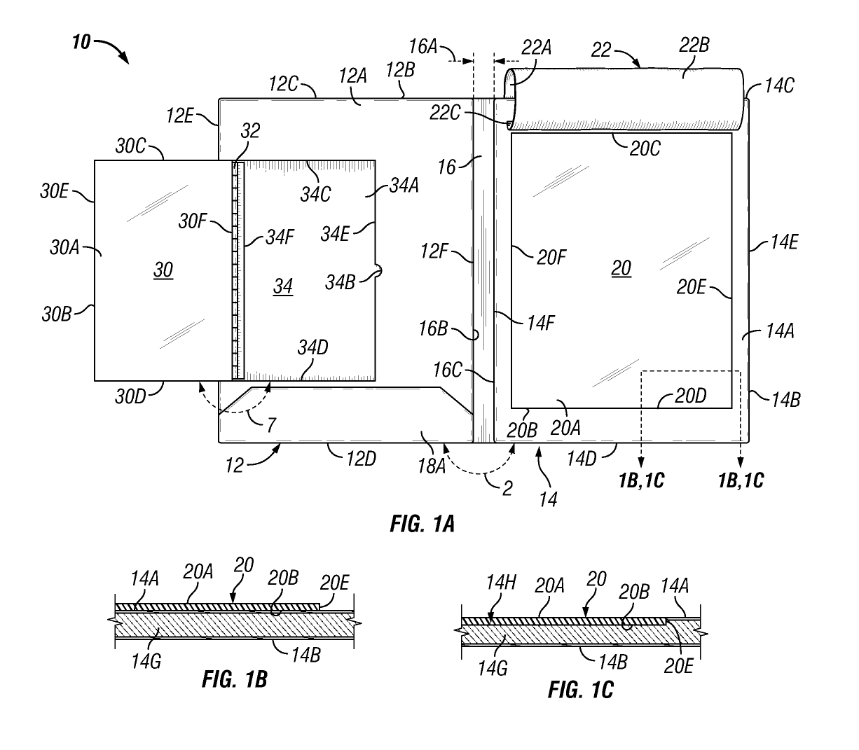

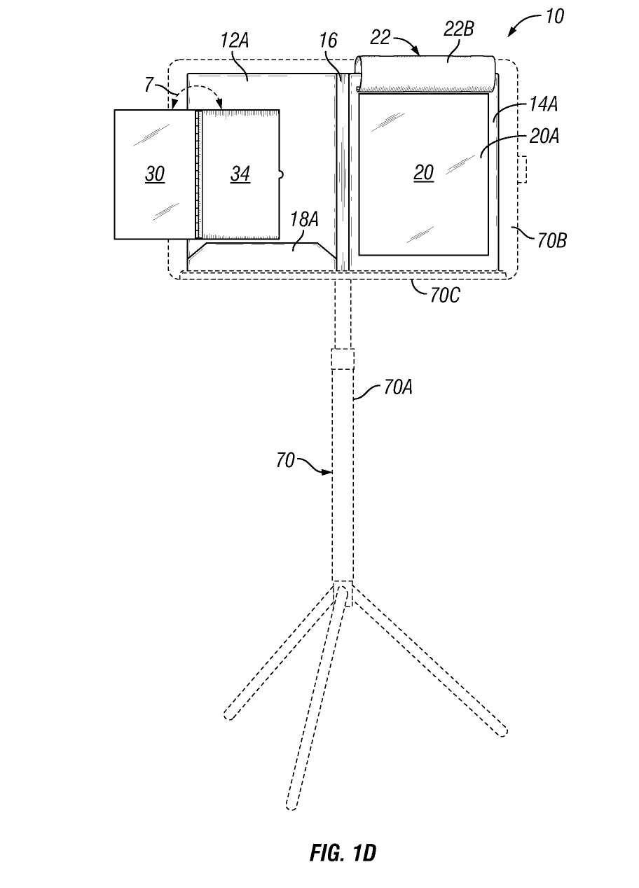

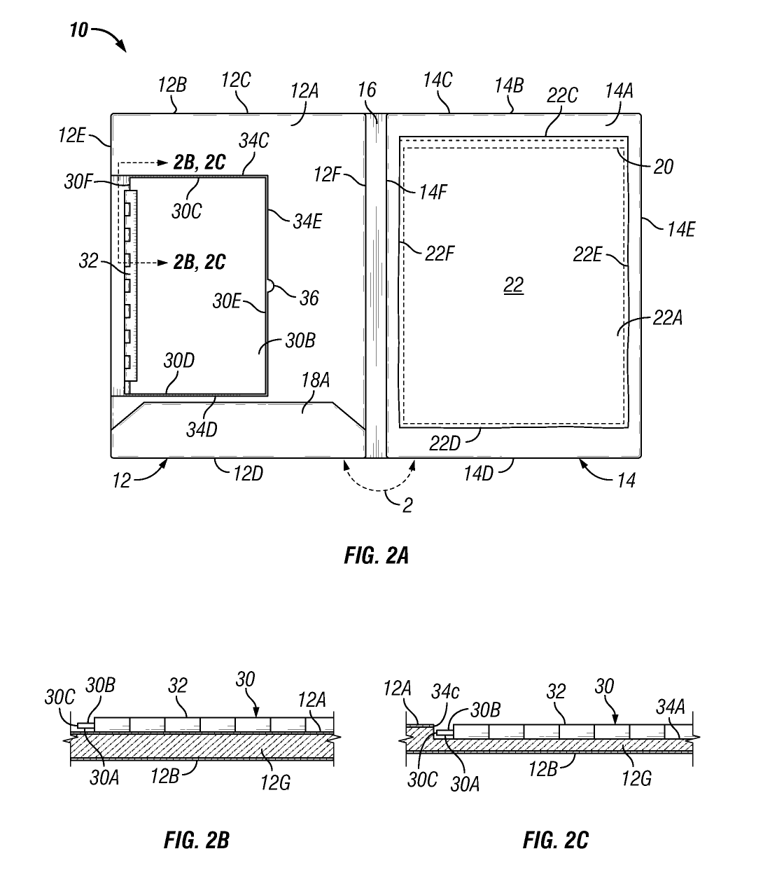

Referring now to FIGS. 1A-1D and 2A-2C there is depicted an embodiment of a mirrored portfolio or practice notebook 10 of the present disclosure shown in an open position with a left hinged mirror 30 in an extended, open position and a right mirror 20 in a fixed position with its mirrored surface 20a exposed. A protective cover 22 is shown pulled back. A small pocket 18a is shown on the left inside front cover 12. More particularly, the mirrored portfolio or folder (or presentation folder) 10 of this embodiment comprises a front cover 12 having a front cover inside face 12a, a front cover outside face 12b, a front cover top edge 12c, a front cover bottom edge 12d opposite the front cover top edge 12c, a front cover outside edge 12e, and a front cover inside edge 12f opposite the front cover outside edge 12e. The mirrored portfolio or folder 10 of this embodiment also comprises a back cover 14 having a back cover inside face 14a, a back cover outside face 14b, a back cover top edge 14c, a back cover bottom edge 14d opposite the back cover top edge 14c, a back cover outside edge 14e, and a back cover inside edge 14f opposite the back cover outside edge 14e. A flexible spine or backbone section 16 hingedly connects or foldably joins the front cover inside edge 12f to the back cover inside edge 14f to permit the front cover 12 and back cover 14 to open and close about the hinged connection 16 along a desired spine angle 2.

In this embodiment, the mirrored portfolio 10 further comprises a first mirror 20 attached to the back cover inside face 14a, the first mirror 20 having a front surface 20a, a rear surface 20b, a top edge 20c, a bottom edge 20d opposite the top edge 20c, an inside edge 20f and an outside edge 20e opposite the inside edge. The mirrored portfolio 10 further comprises a second mirror 30 attached to the front cover inside face 12a, the second mirror 30 having a front surface 30a, a rear surface 30b, a top edge 30c, a bottom edge 30d opposite the top edge 30c, an inside edge 30f and an outside edge 30e opposite the inside edge 30f. In this embodiment, the second mirror inside edge 30f is hingably attached to the front cover inside face 12a proximate the front cover outside edge 12e to permit the second mirror 30 to be adjustably rotated about the hinged attachment 32 between a closed position (shown in FIG. 2A) and an open position (shown in FIG. 1A), the closed position being defined as where the second mirror front surface 30a rests against the front cover inside face 12a, the open position being defined as where the second mirror front surface 30a is rotated away from the front cover inside face 12a to a desired second mirror angle 7.

In preferred embodiments, one or more of the inside covers 12a, 14a contain a pocket 18a, 18b, 18c for holding papers, notes, sheet music, or other desired items and the like (see, e.g., FIGS. 1A, 2A, 3, 4, and 5A). The style of the pockets may be any of those known in the art of folios and notebooks, such as a two-sided simple flap 18b, 18c (attached along the lower and outside edges of the inside covers) or a three-sided open top pocket (attached along the lower, inside and outside edges of the inside covers) behind which the papers may be placed. In another embodiment, the pocket(s) may be an expandable or gusseted pocket. In one embodiment, at least one pocket is built into the front cover inside face. In another embodiment, at least one pocket is built into the back cover inside face. In yet another embodiment, the front and back cover each further comprise one or more pockets. Additionally, the front and/or back covers (inside or outside faces) may further comprise one or more pen/pencil holders and/or business card holder, or name card. Also, embodiments of the present invention may also include one or more external pockets.

In the embodiments depicted in FIGS. 1A-1D and 2A, the front surface or face 20a of the first mirror 20 contains or otherwise projects a reflective mirror finish (of any variety known in the art) and the rear surface 20b of the first mirror 20 is mounted to the back cover inside face 14a using glue, adhesives, double sided adhesive tape, fasteners, hook and loop fasteners, clips, mirror clips, J-shaped mirror clips, picture frame turn buttons, magnetic mounts, hinges or the like. As such, the mirror 20 may be permanently affixed, movably affixed, or removably affixed to the back cover inside face 14a. If the mirror 20 breaks, it can be replaced. The mirror 20 may be of any desired size and shape. In a preferred embodiment, the mirror 20 covers a substantial portion of the back cover inside face 14a such as illustrated in FIG. 1A. In another embodiment, the mirror 20 covers all or substantially all of the back cover inside face 14a. In one embodiment, the mirror 20 is mounted directly to the back cover inside face 14a such as illustrated in FIG. 1B. In another embodiment, as illustrated in FIG. 1C, the mirror 20 may also be mounted within a recessed area 14h of the back cover inside face 14a to permit the mirror 20 to be mounted flush with the back cover inside face 14a, or countersunk into the recessed area 14h. When the mirror 20 is mounted within the recessed area 14h, this helps to further protect the mirror and its edges.

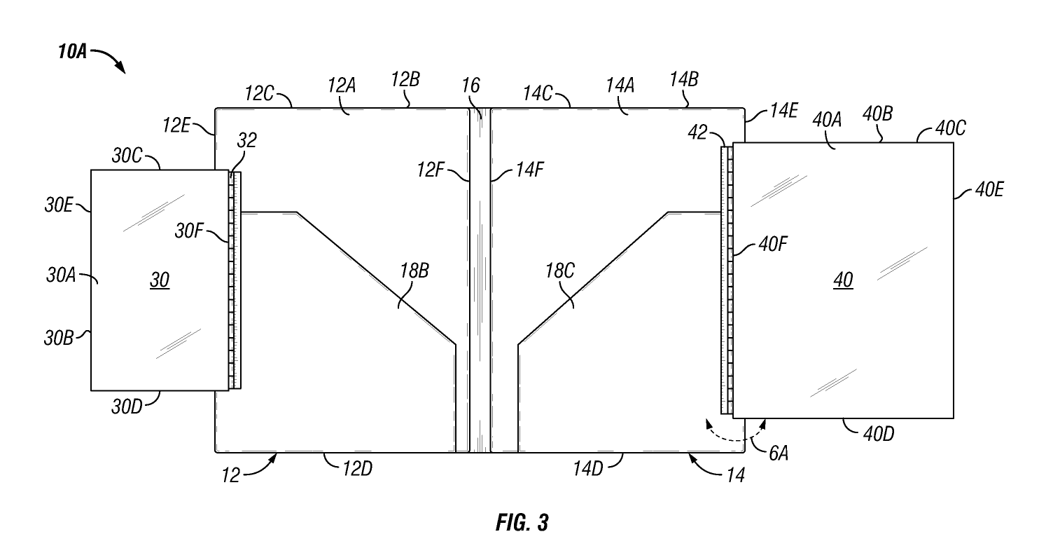

Referring now to FIGS. 3, 4, and 5A-5E, there are shown various representative arrangements illustrating how the first mirror 40, 50 or 60 may be hingably mounted to the back cover inside face 14a.

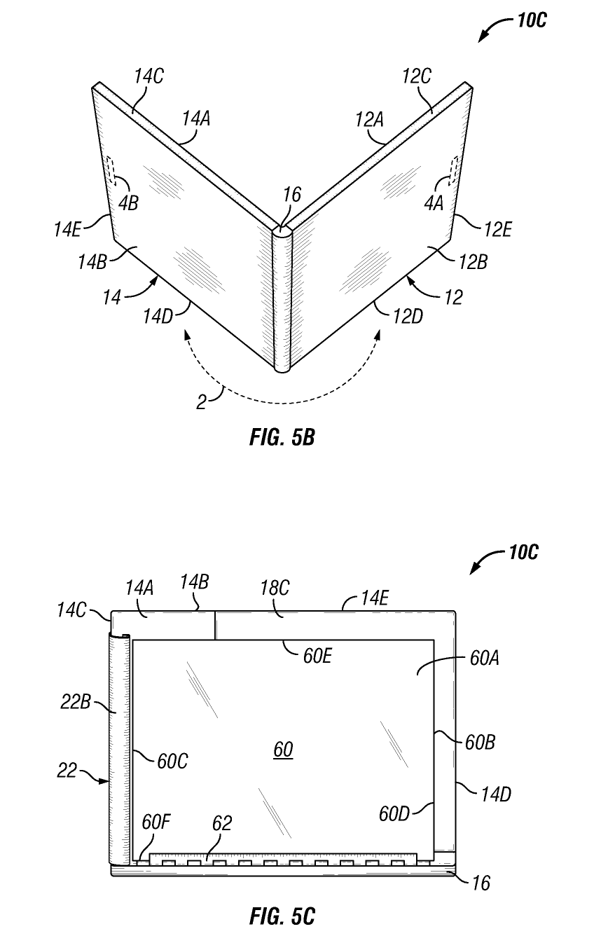

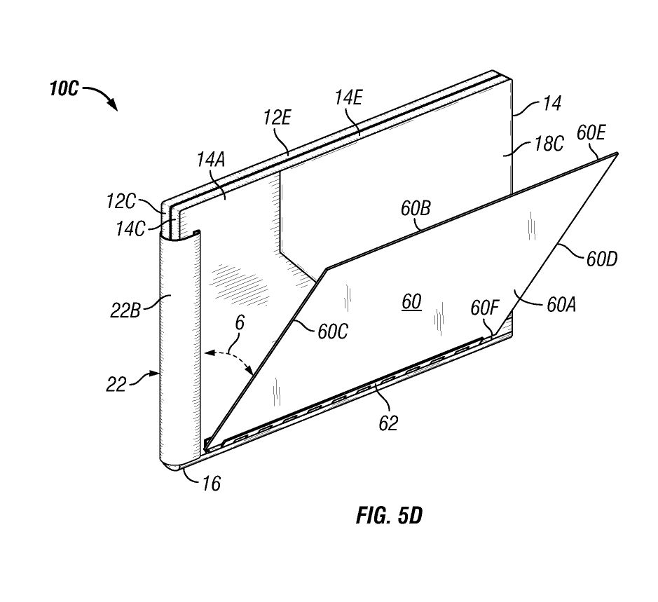

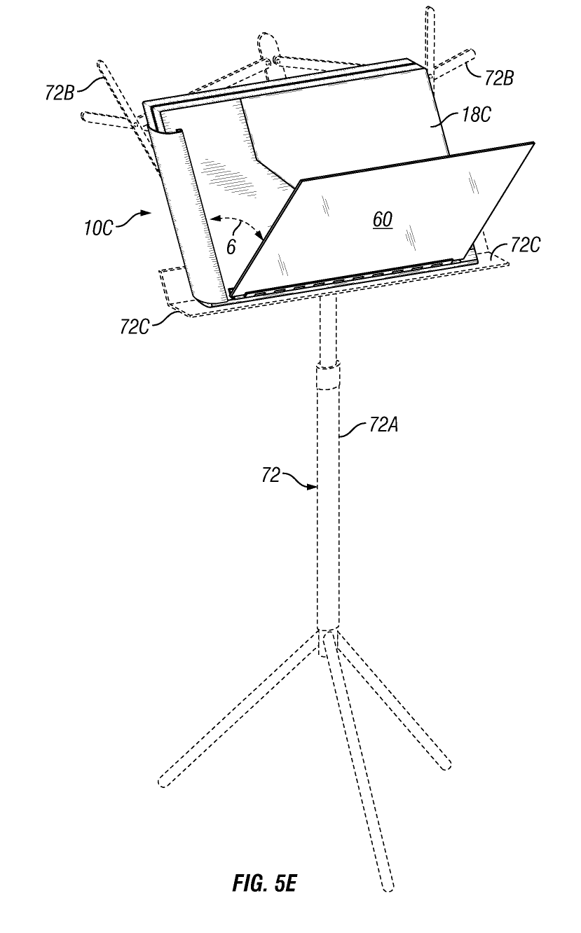

For example, FIGS. 5A, and 5C-5E show an embodiment wherein the first mirror 60 has a front surface 60a, a rear surface 60b, a top edge 60c, a bottom edge 60d opposite the top edge 60c, an inside edge 60f and an outside edge 60e opposite the inside edge. In this embodiment, the first mirror 60 inside edge 60f is hingably attached with a hinge device 62 to the back cover inside face 14a proximate the back cover inside edge 14f to permit the first mirror 60 to be rotated about its hinge 62 to a desired first mirror angle 6. In one embodiment, the front surface 60a of the first mirror 60 contains or otherwise projects a reflective mirror finish, i.e., the mirrored finish appears on the surface facing the user when the right (first) mirror 60 is rotated about its hinge 62 to its right-most position. In another embodiment, the rear surface 60b of the first mirror 60 contains or otherwise projects a reflective mirror finish, i.e., the mirrored finish appears on the surface facing the user when the right (first) mirror 60 is rotated about its hinge 62 to its left-most position. In yet another embodiment, both the front surface 60a and rear surface 60b of the first mirror 60 contain or otherwise project a mirrored finish so that a mirrored finish will face the user when the first mirror 60 is rotated about its hinge 62 to either its leftmost or rightmost position.

The first mirror 60 may be of any desired size and shape. In a preferred embodiment, the mirror 60 covers a substantial portion of the back cover inside face 14a such as illustrated in FIGS. 5A and 5C. In another embodiment, the mirror 60 covers all or substantially all of the back cover inside face 14a. In one embodiment, the hinge 62 for the mirror 60 is mounted directly to the back cover inside face 14a proximate to the back cover inside face 14a inside edge 14f. In another embodiment, the hinge 62 for the mirror 60 is mounted directly to the back cover inside face 14a along the back cover inside face 14a inside edge 14f such as illustrated in FIG. 1B. In another embodiment, the hinge 62 of the mirror 60 may be mounted to, or otherwise integrated into the spine or backbone 16 much like a leaf of the folio. In another embodiment, the mirror 60 may also be mounted within a recessed area 14h of the back cover inside face 14a to permit the mirror 60 to be mounted flush with the back cover inside face 14a, or countersunk into the recessed area 14h. When the mirror 60 is mounted within the recessed area 14h, this helps to further protect the mirror and its edges. In one embodiment, the first mirror angle 6 ranges between about 0° and 180° when the hinge 62 is mounted proximate the rear cover inside edge 14f. When the hinge 62 is mounted along the spine 16, and where the spine angle 2 ranges between about 0° and about 360° then the first mirror angle 6 may also range between about 0° and about 360°.

The first mirror may also be hingably connected to the folio in other configurations. For example, referring now to FIG. 3 there is illustrated an embodiment wherein the first mirror 40 has a front surface 40a, a rear surface 40b, a top edge 40c, a bottom edge 40d opposite the top edge 40c, an inside edge 40f and an outside edge 40e opposite the inside edge. In this embodiment, the first mirror 40 inside edge 40f is hingably attached with a hinge device 42 to the back cover inside face 14a proximate the back cover outside edge 14e to permit the first mirror 40 to be rotated about its hinge 42 to a desired first mirror angle 6a. In one embodiment, the front surface 40a of the first mirror 40 contains or otherwise projects a reflective mirror finish, i.e., the mirrored finish appears on the surface facing the user when the right (first) mirror 40 is rotated about its hinge 42 to a right-side (or open) position extending outward from the outer edge 14e. In another embodiment, the rear surface 40b of the first mirror 40 contains or otherwise projects a reflective mirror finish, i.e., the mirrored finish appears on the surface facing the user when the right (first) mirror 60 is rotated about its hinge 42 to its left-most (closed) position. In yet another embodiment, both the front surface 40a and rear surface 40b of the first mirror 40 contain or otherwise project a mirrored finish so that a mirrored finish will face the user when the first mirror 40 is rotated about its hinge 42 to either its leftmost or rightmost position.

The first mirror 40 may be of any desired size and shape. In a preferred embodiment, the mirror 40 covers a substantial portion of the back cover inside face 14a such as illustrated in FIG. 3. In another embodiment, the mirror 40 covers all or substantially all of the back cover inside face 14a. In one embodiment, the hinge 42 for the mirror 40 is mounted directly to the back cover inside face 14a proximate to the back cover inside face 14a outside edge 14e. In another embodiment, the hinge 42 for the mirror 40 is mounted directly to the back cover inside face 14a along the back cover inside face 14a outside edge 14e. In another embodiment, the hinge 42 of the mirror 40 may be mounted to, or otherwise integrated into the rear cover outer edge 14e. In another embodiment, the mirror 40 may also be mounted within a recessed area 14h of the back cover inside face 14a to permit the mirror 40 to be mounted flush with the back cover inside face 14a, or countersunk into the recessed area 14h. When the mirror 40 is mounted within the recessed area 14h, this helps to further protect the mirror and its edges. In one embodiment, the first mirror angle 6a ranges between about 0° and 180° when the hinge 42 is mounted proximate the rear cover outside edge 14e. When the hinge 42 is mounted along the outer edge 14e then the first mirror angle 6a may range between about 0° (where the mirror front surface 40a contacts the rear cover inside face 14a) and about 360° (where the mirror rear surface 40b contacts the rear cover outside face 14b).

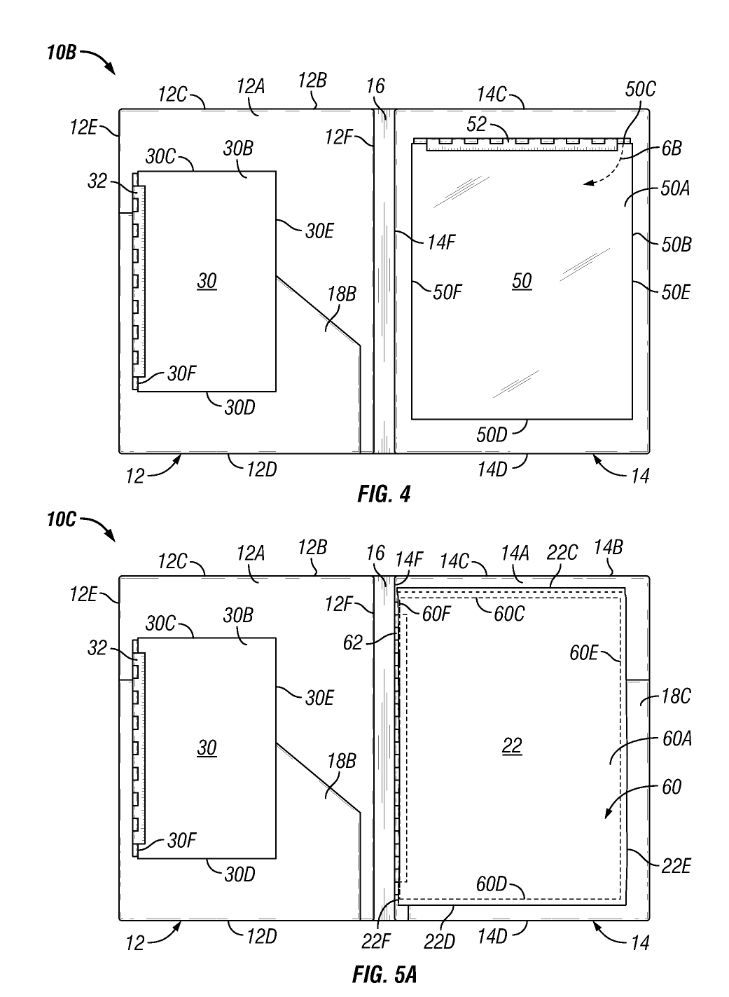

The first mirror may also be hingably connected to the folio in other configurations along either the top edge or bottom edge of the rear cover. For example, referring now to FIG. 4 there is illustrated an embodiment wherein the first mirror 50 has a front surface 50a, a rear surface 50b, a top edge 50c, a bottom edge 50d opposite the top edge 50c, an inside edge 50f and an outside edge 50e opposite the inside edge. In this embodiment, the first mirror 50 top edge 50c is hingably attached with a hinge device 52 to the back cover inside face 14a proximate the back cover top edge 14c to permit the first mirror 50 to be rotated about its hinge 52 to a desired first mirror angle 6b. In one embodiment, the front surface 50a of the first mirror 50 contains or otherwise projects a reflective mirror finish, i.e., the mirrored finish appears on the surface facing the user when the right (first) mirror 50 is in its closed position as shown in FIG. 4. In another embodiment, the rear surface 50b of the first mirror 50 contains or otherwise projects a reflective mirror finish, i.e., the mirrored finish appears on the surface facing the user when the right (first) mirror 50 is rotated upward about its hinge 52 to its up-most (open) position. In yet another embodiment, both the front surface 50a and rear surface 50b of the first mirror 50 contain or otherwise project a mirrored finish so that a mirrored finish will face the user when the first mirror 50 is rotated about its hinge 52 to either its closed or open positions.

The first mirror 50 may be of any desired type, size and shape. In a preferred embodiment, the mirror 50 covers a substantial portion of the back cover inside face 14a such as illustrated in FIG. 4. In another embodiment, the mirror 50 covers all or substantially all of the back cover inside face 14a. In one embodiment, the hinge 52 for the mirror 50 is mounted directly to the back cover inside face 14a proximate to the back cover inside face 14a top edge 14c. In another embodiment, the hinge 52 for the mirror 50 is mounted directly to the back cover inside face 14a along the back cover inside face 14a top edge 14c. In another embodiment, the hinge 52 of the mirror 50 may be mounted to, or otherwise integrated into the rear cover top edge 14c. In another embodiment, the mirror 50 may also be mounted within a recessed area 14h (like shown in FIG. 1C, for example) of the back cover inside face 14a to permit the mirror 50 to be mounted flush with the back cover inside face 14a, or countersunk into the recessed area 14h. When the mirror 50 is mounted within the recessed area 14h, this helps to further protect the mirror and its edges. In one embodiment, the first mirror angle 6b ranges between about 0° and 180° when the hinge 52 is mounted proximate the rear cover top edge 14c. When the hinge 52 is mounted along the top edge 14c then the first mirror angle 6b may range between about 0° (where the mirror rear surface 50b contacts the rear cover inside face 14a) and about 360° (where the mirror front surface 50a contacts the rear cover outside face 14b).

Referring now to FIGS. 1A, 1D, 2A-2C, 3, 4 and 5A, there is shown a representative arrangement illustrating how the second mirror 30 may be hingably mounted to the front cover inside face 12a. For example, the second mirror 30 has a front surface 30a, a rear surface 30b, a top edge 30c, a bottom edge 30d opposite the top edge 30c, an inside edge 30f and an outside edge 30e opposite the inside edge. In this embodiment, the second mirror 30 inside edge 30f is hingably attached with a hinge device 32 to the front cover inside face 12a proximate the front cover outside edge 12e to permit the second mirror 30 to be rotated about its hinge 32 to a desired second mirror angle 7. In one embodiment, the front surface 30a of the second mirror 30 contains or otherwise projects a reflective mirror finish, i.e., the mirrored finish appears on the surface facing the user when the left (second) mirror 30 is rotated about its hinge 32 to a left-side (or open) position extending outward from the outer edge 12e. In another embodiment, the rear surface 30b of the second mirror 30 contains or otherwise projects a reflective mirror finish, i.e., the mirrored finish appears on the surface facing the user when the left (second) mirror 30 is rotated about its hinge 32 to its right-most (closed) position. In yet another embodiment, both the front surface 30a and rear surface 30b of the second mirror 30 contain or otherwise project a mirrored finish so that a mirrored finish will face the user when the second mirror 30 is rotated about its hinge 32 to either its leftmost or rightmost position.

The mirror 30 may be of any desired type, size and shape. In a preferred embodiment, the mirror 30 covers approximately one-third to one-half of the front cover inside face 12a such as illustrated in FIG. 1A. In another embodiment, the mirror 30 covers a substantial portion of the front cover inside face 14a such as illustrated in FIG. 3. In yet another embodiment, the left mirror 30 is smaller than the right mirror 20. In another embodiment, the mirror 30 covers all or substantially all of the front cover inside face 12a. In one embodiment, the hinge 32 for the second mirror 30 is mounted directly to the front cover inside face 12a proximate to the front cover inside face 12a outside edge 12e. In another embodiment, the hinge 32 for the second mirror 30 is mounted directly to the front cover inside face 12a along the front cover inside face 12a outside edge 12e. In another embodiment, the hinge 32 of the second mirror 30 may be mounted to, or otherwise integrated into the front cover outer edge 12e. In another embodiment, the second mirror 30 may also be mounted within an optional recessed area 34 of the front cover inside face 12a to permit the second mirror 30 to be mounted flush with the front cover inside face 12a, or countersunk into the recessed area 34. The recessed area 34 has a bottom surface 34a, a tabbed cut-out 34b for opening left side mirror, a top edge 34c, a bottom edge 34d, an outside edge 34e and an inside edge 34f. When the second mirror 30 is mounted within the recessed area 34, this helps to further protect the mirror and its edges. In one embodiment, the second mirror angle 7 ranges between about 0° and 180° when the hinge 32 is mounted proximate the front cover outside edge 12e. When the hinge 32 is mounted along the outer edge 12e then the second mirror angle 7 may range between about 0° (where the mirror front surface 30a contacts the front cover inside face 12a) and about 360° (where the mirror rear surface 30b contacts the front cover outside face 12b).

The mirrors used in the present invention are preferably constructed of a plastic material to minimize the potential for breakage or shattering, and to reduce the weight, but the mirror could be any suitable substrate capable of receiving a reflective coating. If a glass mirror is employed, it is preferred that it be a safety glass mirror having a special protective film on the back surface to prevent injuries in the event the mirror is broken. It is preferred that the mirrors used for the present invention be plane mirrors (those with flat reflective surfaces) so that they create virtual images of the same size as the original object. However, convex or concave mirrors could be used as may be desired. If desired, the one or more mirrors could be of a non-reversing mirror variety that provide a non-reversed image of its subject. The mirror(s) could be made from a plastic mirror sheet material, such as, e.g., mirrored acrylic, polystyrene, plexiglass, polycarbonate and the like such as those mirrored plastics offered by American Acrylics (www.americanacrylics.com), U.S. Plastics Corp. (www.usplastic.com) and Plaskolite, Inc. (Columbus, Ohio, www.plaskolite.com). For example, a ⅛-inch thick, or ¼-inch (or other thickness) acrylic or other plastic mirror could be cut to the desired size and shape for use in various embodiments disclosed herein of the first and second mirrors. Additionally, the plastic mirror could be double-sided (first surface/two-sided mirror) so that a mirrored/reflective surface is present on both sides of the mirror. Acrylic mirror sheets are the most popular lightweight and flexible mirror substrate available typically in the widest range of thicknesses. PETG mirror sheets are higher impact strength than acrylic and offers versatile fabrication properties with good impact strength, good design flexibility and speed of fabrication. PETG mirror is available in 0.030″-0.118″ in 48″×96″ sheets. The thinner PETG gauge sheet is ideal for the fabrication of children's toys, cosmetic uses and office supplies. Polycarbonate mirror sheets offer a very high impact strength. The optics of polycarbonate are comparable to acrylic, but its strength is 30 times stronger.

Because acrylic has a relatively soft surface and is flexible, some imperfections or distortions may occur in a mirrored acrylic mirror. Visual distortion is a function of viewing distance and material thickness. As such, according to websites plaskolite.com and theplasticshop.co.uk, depending on the size of the mirror, when using a plastic mirror material, a thicker mirror is preferred to maintain better optical integrity by reducing the possibility that the mirror could bend and distort the image. Mirrored acrylic is a reflective film applied to a substrate. As such, when the substrate is affixed to another surface, both of the materials will in time conform to the underlying supporting surface irregularities, thus, when mounting the mirror on the cover of the folio, it is preferred that the mounting surface of the cover be a smooth, rigid, sturdy flat backing. When using screws or other mechanical attachment to attach the mirror to the folio, care should be used to evenly tighten down the mirror to minimize distortion. When using a plastic mirror, where the mirror will be adhesively attached to the folio cover, the adhesive selected should be one that does not attack the backing material of the mirror. One such suitable adhesive is a chemically-curing, solvent free sealant and adhesive combining the best qualities of silicone and polyurethane sealants, such as the “Mirror Mate” mirror adhesive product sold by www.theplasticshop.co.uk. The mirrors may also be obtained with an adhesive backing that transfers an adhesive on the sheet once its protective paper layer is pulled off. An adhesive backed mirror has advantages over adhesives that are applied by hand that can cause messy edges and non-uniform adhesive coverage. Other suitable adhesives and mirror attachment devices are known in the art.

In another embodiment of the present invention, the mirrored folio further comprises a flexible protective material 22 for covering the first mirror, the flexible material having a topside outer surface 22a, an underside surface 22b, a top edge 22c, a bottom edge 22d, a right side edge 22e and a left side edge 22f, the flexible material 22 being attached to the back cover inside face 14a to permit the protective material 22 to cover the mirror (e.g., 20) (as shown in FIG. 2A) when the mirror is not in use and to be pulled back (as shown in FIG. 1A) to expose the mirror when the mirror is to be used, wherein the flexible protective material 22 may be selected from the group consisting of: synthetic cloth, natural cloth, flannel cloth, synthetic and natural cloth blends, soft suede-like material, plastic sheet material, rubber sheet material, and the like. The protective material may be mounted proximate the mirror in any number of ways, including, e.g., using adhesives, tape, sewing, and other fasteners, such as hook and loop fasteners. In the embodiment depicted in FIGS. 1A and 2A, the protective cover 22 upper edge 22c is preferably mounted or attached proximate the mirror upper edge, e.g., 20c.

The hinges 32, 42, 52 and 62 described herein used to secure one or more mirrors to the folio covers preferably are friction hinges to permit the mirrors 30, 40, 50 and 60 to be rotated about their hinge angles and to hold the mirrors in the desired position. The hinge(s) may be a single hinge (continuous hinge), preferably extending substantially the entire length of the mirror edge, or otherwise extending a sufficient distance along the edge of the mirror to support the mirror. The hinge may also comprise one hinge, or a plurality of spaced-apart hinges. Various hinges known in the art can be employed in the present invention, including those selected from the group consisting of: metal, plastic, rubber or cloth hinges, inset hinges, overlay hinges, variable overlay hinges, torsion hinges, concealed hinges, semi-concealed hinges, non-mortise hinges, Soss hinges, Sepa hinges, barrel hinges, knife hinges, pin hinges, clip top hinges, back-to-back wrap around hinges, continuous hinges, slotted piano hinges, wrap around slotted piano hinges, partial wrap hinges, inset hinges, fully concealed hinges, tray table hinges, pivot hinges, roto hinges, stop hinges, butt hinges, specialty hinges, double action hinges, pivot hinges, single pin hinges, stop hinges, staple hasp catch hinges, Blum brand hinges, slide rail hinges, fixed pin hinges, spring hinges, box hinges, flush hinges, mortise hinges, parliament hinges, fastener hinges, friction hinges, strap hinges, tee hinges, finial tipped hinges, ball tipped hinges, and other metal hinges offered by, e.g., Rockler Woodworking and Hardware (Medina, Minn., www.rockler.com); www.houseofantiquehardware.com; and www.hardwaresource.com; for example. Different metals may be employed as are known in the art, such as, for example, brass, aluminum and stainless steel.

Additionally, plastic hinges, such as those made from flexible alloyed polymeric materials, modified polyolefin copolymers, or other plastics, acrylic, etc., may also be employed, such as, for example, the plastic pinless butt hinges and continuous hinges manufactured and sold by, e.g., C. E. Shepherd Company (Houston, Tex., www.ceshepherd.com). For example, these plastic hinges are advanced one-piece, molded, plastic, pinless hinges created for silent and maintenance-free service with never a need for lubrication. They will not fatigue or deteriorate even in wet or corrosive environments. Plastic hinges are available in continuous hinge style (similar to a piano hinge) or butt hinges in a range of standard sizes, and custom hinges can be molded to desired specifications. Other plastic hinges are available such as, for example, the acrylic hinges, piano hinges, polypropylene hinges, living hinges, and thermoplastic hinges (offset or flush) offered by U.S. Plastic Corp. (Lima, Ohio, www.usplastic.com) or the plastic hinges, piano hinges, butt hinges, and continuous hinges offered by Monroe Hinge & Stamping Co. (Auburn Hills, Mich., www.monroeengineering.com).

Also, cloth hinges could be used in the present invention to attach the mirrors to the folio. For example, glass cloth, fiberglass cloth, Kevlar brand cloth, or the cloth-bound hinges used on pressboard report covers, such as those made under the Universal brand, and other cloth hinge materials known in the art, including hinge tape materials, could be used.

Rubber (or other similar materials) or rubber gasket glass hinges could also be employed in creating a hinge for attaching one edge of a mirror to the folio similar to the glass-to-wall rubber hinges offered by Custom Hardware Manufacturing, Inc. (CHMI)(Keokuk, Iowa, www.chmi.com, and described in U.S. Pat. No. 5,687,869, incorporated herein by reference).

Additionally, other mechanisms for attaching the second mirror could be employed, including, a double retractable arm structure, a pivot arm structure, a telescoping structure and the like.

The covers 12 and 14 may be constructed as with any folio, presentation folder, music folder, diary, day planner and the like, and can be made from any number of materials known and used in the art including, without limitation, plastics, nylon, vinyl, leather, rawhide, leatherette, faux leather, pressboard, synthetic materials, paper/cardboard, cloth and the like. Exemplary folders may include an internal structural layers such as a pressboard panels that are in-turn covered by an outside covering of choice, e.g., vinyl, leather, leatherette, etc. The PlanAhead brand of folios may be modified according to the teachings of the present invention to include the features described herein. The covers 12, 14 may employ brass reinforced corners (not shown). The size of the folio (outside dimensions) can vary according to the desired use. Also, Company Folders, Inc. (Keego Harbor, Mich., www.companyfolders.com) offers a wide variety of folders, binders, portfolios, presentation folders and the like that could be suitably outfitted with the mirrors according to the teachings herein to form a mirrored portfolio embodiments of the present invention. Additionally, Levenger Company (Delray Beach, Fla., www.levenger.com) carries a line of folios that could also be modified according to the teachings of the present disclosure to become mirrored portfolios of the present invention.

The zippered style day planners described by White, U.S. Pat. No. 6,017,062 (which is incorporated herein by reference in its entirety for all purposes), and offered by The Mead Corporation, Dayton, Ohio, could also serve as an exemplary structure to modify according the present teachings to create a zippered, mirrored portfolio. In this case, where the planner is a ring binder style, the first mirror could be mounted on the inside back cover, or could be mounted on a page/leaf structure that could be hole-punched and inserted into the ring binder. Likewise, the second mirror could be hingably mounted on the inside front cover of the planner, or could be hingably mounted to a page/leaf that can be inserted into the ring binder.

The mirrored portfolio or presentation folder/notebook may further comprise one or more closure devices or fasteners 4a, 4b, 4c, 8, for securing the front cover to the back cover when the spine angle is either about 0° (where the front cover inside face faces the back cover inside face) and 360° (where the front cover outside face faces the back cover outside face), the closure devices being selected from the group consisting of hook and loop fasteners, clasp closures, snap closures, magnet closures, ties, ribbons, straps, elastic loops, elastic ties, buttons, zippers, belt with fastener, buckles, loop and belt strap enclosures, belt and buckle enclosures, belt and snap enclosures, and the like and other closure devices used on folios and notebooks as are known in the art (e.g., as shown in White, U.S. Pat. No. 6,017,062. The folio may also employ an external strap or handle 3 as may be desired.

Also, the folio may also be equipped with one or more attachment devices (e.g., 8) for securing the portfolio practice mirror to a stand, the one or more attachment devices being selected from the group consisting of ties, fasteners, hook and loop fasteners, straps, elastic loops, button fasteners, and clips.

For example, music folders often are oversized (e.g., about 12 inches wide and 15 inches tall) compared with standard letter-size note folios. Exemplary custom leather music folders, such as the Pollock Leather Music Folder (www.stephen-pollock.com) could be outfitted with the mirrors according to the teachings herein to form a mirrored music folder embodiment of the present invention.

Similarly, standard or padded music folders could also be modified according to the present teachings to create mirrored music folder embodiments of the present invention. For example, “The Black Folder” is a popular, lightweight, ergonomic choral music folder measuring 10¾ inches by 12½ inches, available from, e.g., The Music Mart, Inc. (Albuquerque, N. Mex., www.musicmart.com), and Small World Musicfolder.com Inc. (Vancouver, BC, www.musicfolder.com). This folder is a strong, heavy-duty construction with leatherette exterior (and interior pockets) for long durability. This folder employs a retainer strap on its interior bottom to prevent loose music from sliding out, and can also be used to holds the folder open. This folder also features a button on the folder to unsnap the bottom strap to open the folder wider. The folder also employs 10 elastic cords installed in an aluminum hinge to holds music in place for complete security. A separate ring binder, which can be threaded into the strings, can be added to the folder. The folder uses sewn edges (double-sewn on top and bottom), a heavy weight hand strap, and brass corners. This folder is also provided with two gusseted pockets with ½″ of expansion. Where the mirrored folio of the present invention is used by a person standing and holding the folder (e.g., a choral singer, a presenter, etc.) it is preferred that the mirrors be lightweight plastic material. Similar band and orchestra music folders are available and can be modified according to the present teachings herein to construct mirrored folio embodiments of the present invention from sources such as www.hickeys.com, www.protecmusic.com (padded music folders).

In one embodiment (depicted generally in the cross-sectional views FIGS. 1B, 1C, 2B and 2C), the back cover 14 and/or front cover 12 (not shown) may further comprise a layer of padding, e.g., 14g (shown on back cover) and 12g (shown on the front cover). As such, as may be desired for aesthetics and/or to better protect the contents of the mirrored portfolio (including the mirror(s), a padded layer 12g may be employed between the front cover inside face 12a and the front cover outside face 12b and/or a padded layer 14g may be employed between the back cover inside face 14a and the back cover outside face 14b. The padding material may be any suitable padding material, such as those padding materials used in existing padded folios, padded presentation folders, padded music folders, etc. and those selected from the group consisting of: foam, neoprene, quilt batting, felt, sueded polyethylene, polyester padding, air cell padding, and the like as are known in the art of folios.

The spine or backbone 16 may be constructed in any number of ways, and have varying spine widths 16a. For example, in one embodiment, the spine 16, front cover 12 and back cover 14 may be formed from the same sheet of material. In another embodiment, the flexible spine or backbone 16 is simply formed by the joining together of front cover inside edge 12f to back cover inside edge 14f. In one embodiment, the front cover 12 and back cover 14 are formed from a contiguous material, and the spine 16 is simply the vertical midpoint between the front cover outside edge 12e and the back cover outside edge 14e. In yet another embodiment, the spine 16 is formed by creating a fold or crease at the juncture of the front cover inside edge 12f to the back cover inside edge 14f. As will be understood, the width 16a of the spine 16 can be varied according to the desired volume of materials (sheet capacity) to be contained inside of the mirrored portfolio 10. In another embodiment, the spine 16 is a substantially flat or partially curved, rigid surface having a left edge 16b that is attached (via flexible or hinged attachment) to the front cover inside edge 12f and a right edge 16c that is attached (via flexible or hinged attachment) to the back cover inside edge 14f. In other embodiments, the spine 16 may be a hinge (as described herein or otherwise known in the art), a flexible material, a ring binder ringed notebook spine, a locking slant-D or round ring binder spine, a zippered binder spine, a presentation folder backbone, a folder single-score backbone, a folder double-score backbone, a folder triple-score backbone a velo-bound spine, a spiral bound spine, a twin loop wire binding, a comb binding, a ring binding, tape binding, saddle stitch binding, perfect binding, stapled binding, a music folder spine, a book bindery spine, and the like.

The folio embodiments employing a hinged primary mirror may also be modified to create a storage area in the inside back cover 14a for storing papers, pencils, etc. The mirror would serve as a hinged covering for this storage area.

In a preferred embodiment, the spine angle 2 is adjustable between about 0° (where the front cover inside face 12a faces, or touches, or is substantially parallel with the back cover inside face 14a) and about 360° (where the front cover outside face 12b faces, or touches or is substantially parallel with the back cover outside face 14b). The spine 16 can also be constructed as with the spines of typical folios, portfolios, padfolios, presentation folders, diaries, and the like.

Referring now to FIGS. 1D and 5E, there are disclosed examples of how two of the mirrored portfolio embodiments described herein might be used. In FIG. 1D, the folio 10 can be placed on a stand (such as a music stand 70 having a base section 70a, a vertical support section 72b, and a horizontal ledge section 70c extending outward from the lower edge of the vertical support section 72. In this embodiment, the folio 10 is opened much like a book, and is placed on the music stand 70 (or piano music ledge, speaker's podium, or is held by hand, etc.). The cover 22 is pulled back from the first (primary) mirror 20 to expose the reflective surface 20a so that the user may observe himself/herself while practicing or actually performing/presenting. As may be desired, the second (secondary) mirror 30 may be opened to a desired mirror angle 7 to provide an extended mirrored view. The folio may be equipped with straps, elastic or other attachment devices 8 to help secure the folio 10 to the stand 70b. In FIG. 5E (and also referring to FIGS. 5A-5D), the folio 10c is displayed on a music stand 72 having a base, 72a, a vertical support section 72 b and a horizontal ledge section 72c extending outwardly from the vertical support section 72b. The folio 10c is opened back on itself so that the outsides of covers 14 and 12 touch each other, and may be secured to each other via fasteners 4a, 4b. The spine 16 of the folio 10c is placed on the music stand ledge 72c or other surface (e.g., podium, piano), and the primary mirror 60 (or 20 from FIG. 1D) faces the user. If the secondary mirror is hingedly attached to the folio 10c, as in FIG. 5E, the user may adjust the angle 6 of the primary mirror as may be desired. The angle adjustment can be useful particularly where the music stand (or podium or piano) is a fixed (non adjustable) angle. When finished, the user may store papers in the one or more pockets of the folio. The folio can then be closed, and if desired, fasteners may be used to keep the folio closed during storage or transport. The folio may have a carrying strap or handle 3 attached. The configuration shown in FIG. 1D is particularly advantageous for use with a musician using longer instruments, such as a violin or guitar.

### Additional Embodiments

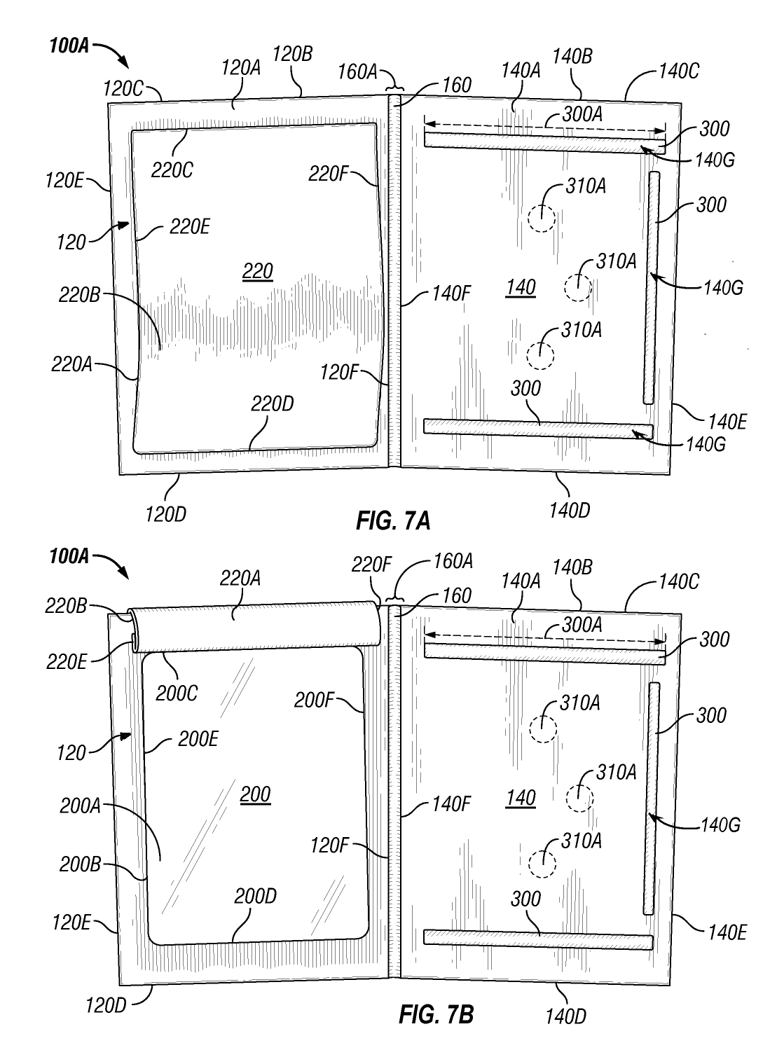

In additional to the above, referring now to FIGS. 7A, 7B, 9A, 9B, 9C, 9D, 9E, 10S, 10B, 12A, 12B, 13A, 13B, 14, and 15, there is shown another mirrored practice portfolio 100A employing removable insertable mirrored portfolio inserts. More particularly, the mirrored portfolio or folder (or presentation folder) 100A of this embodiment comprises a front cover 120 having a front cover inside face 120a, a front cover outside face 120b, a front cover top edge 120c, a front cover bottom edge 120d opposite the front cover top edge 120c, a front cover outside edge 120e, and a front cover inside edge 120f opposite the front cover outside edge 120e. The mirrored portfolio or folder 100A of this embodiment also comprises a back cover 140 having a back cover inside face 140a, a back cover outside face 140b, a back cover top edge 140c, a back cover bottom edge 140d opposite the back cover top edge 140c, a back cover outside edge 140e, and a back cover inside edge 140f opposite the back cover outside edge 140e. A flexible spine or backbone section 160 of width 160a hingedly connects or foldably joins the front cover inside edge 120f to the back cover inside edge 140f to permit the front cover 120 and back cover 140 to open and close about the hinged connection 160 along a desired spine angle 2 (such as shown in FIG. 1A).

In this embodiment, the mirrored portfolio 100A further comprises a first mirror 200 attached to the front cover inside face 120a, the first mirror 200 having a front surface 200a, a rear surface 200b, a top edge 200c, a bottom edge 200d opposite the top edge 200c, an inside edge 200f and an outside edge 200e opposite the inside edge. The front surface or face 200a of the first mirror 200 contains or otherwise projects a reflective mirror finish (of any variety known in the art) and the rear surface 200b of the first mirror 200 is mounted to the front cover inside face 120a using glue, adhesives, double sided adhesive tape, fasteners, hook and loop fasteners, clips, mirror clips, J-shaped mirror clips, picture frame turn buttons, magnetic mounts, hinges or the like. As such, the mirror 200 may be permanently affixed, movably affixed, or removably affixed to the front cover inside face 120a. If the mirror 200 breaks, it can be replaced. The mirror 200 may be of any desired size and shape. In a preferred embodiment, the mirror 200 covers a substantial portion of the front cover inside face 120a such as illustrated in FIG. 7B. In another embodiment, the mirror 200 covers all or substantially all of the front cover inside face 120a. In one embodiment, the mirror 200 is mounted directly to the front cover inside face 120a much like as illustrated in the embodiment of FIG. 1B. In another embodiment, much like as illustrated in FIG. 1C, the mirror 200 may also be mounted within a recessed area (not shown) of the front cover inside face 120a to permit the mirror 200 to be mounted flush with the front cover inside face 120a, or countersunk into the recessed area. When the mirror 200 is mounted within the recessed area, this helps to further protect the mirror and its edges.

In another embodiment of the present invention, the mirrored folio 110A further comprises a flexible protective material 220 for covering the first mirror 200, the flexible material having a an underside surface 220a, topside outer surface 220b, a top edge 220c, a bottom edge 220d, a right side (inside) edge 220e and a left side (outside) edge 220f, the flexible material 220 being attached to the front cover inside face 120a to permit the protective material 220 to cover the mirror (e.g., 200) (as shown in FIG. 7A) when the mirror is not in use and to be pulled back (as shown in, e.g., FIG. 7A) to expose the mirror when the mirror is to be used, wherein the flexible protective material 220 may be selected from the group consisting of: synthetic cloth, natural cloth, flannel cloth, synthetic and natural cloth blends, soft suede-like material, plastic sheet material, rubber sheet material, and the like. The protective material 220 may be mounted proximate the mirror 200 in any number of ways, including, e.g., using adhesives, tape, sewing, and other fasteners, such as hook and loop fasteners. In the embodiment depicted in, e.g., FIGS. 7A and 7B, the protective cover 220 upper edge 220c is preferably mounted or attached proximate the mirror upper edge, e.g., 200c.

The back cover inside face 140a further comprises one or more slits 300 having a slit width 300a for receiving a removable mirrored portfolio insert 230 into the space 140g behind the back cover inside face 140a. In this embodiment, one slit may be horizontally disposed and located proximate and substantially parallel to the back cover top edge 140c. One slit may be horizontally disposed and located proximate and substantially parallel to the back cover bottom edge 140d. One slit may be vertically disposed and located proximate and substantially parallel to the back cover outside edge 140e. In one embodiment, the back cover is outfitted with only one slit in a desired orientation. In another embodiment, the back cover is outfitted with two slits in desired orientations. In yet another embodiment, the back cover is outfitted with three slits as described above and as depicted in, e.g., FIG. 7A. The slits 300 provide an opening of length 300a into an interior space 140g existing or otherwise sandwiched between the back cover outer face 140b and the back cover inner face 140a. As will be appreciated, other slit arrangements would be apparent to someone having the benefit of the present disclosure. For example, the back cover inside face 140a could employ a single diagonal slit (not shown) running from an area proximate the upper inside corner of the back cover inside face 140a downwardly and outwardly to an area proximate the lower outside corner of the back cover inside face 140a.

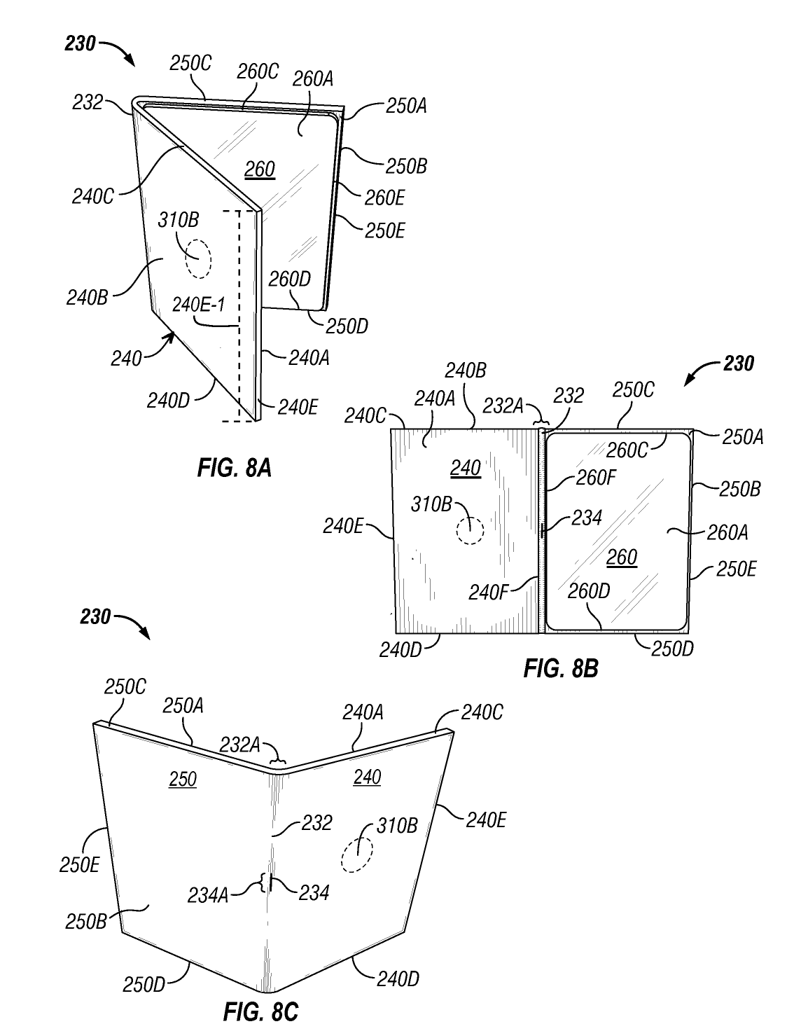

Referring now to FIGS. 8A, 8B and 8C there is depicted an exemplary removable mirrored portfolio insert 230 capable of being inserted into the slits 300 of the practice portfolio 100a, 100b, 100c and 100d described herein. More particularly, the removable mirrored portfolio insert 230 comprises an insert front cover 240 having an insert front cover inside face 240a, an insert front cover outside face 240b, an insert front cover top edge 240c, an insert front cover bottom edge 240d opposite the insert front cover top edge 240c, an insert front cover outside edge 240e of length 240e-1, and an insert front cover inside edge 240f opposite the insert front cover outside edge 240e. The removable mirrored portfolio insert 230 of this embodiment also comprises an insert back cover 250 having an insert back cover inside face 250a, an insert back cover outside face 250b, an insert back cover top edge 250c, an insert back cover bottom edge 250d opposite the insert back cover top edge 250c, an insert back cover outside edge 250e, and an insert back cover inside edge 250f opposite the insert back cover outside edge 250e. A flexible spine or backbone section 232 of width 232a hingedly connects or foldably joins the front cover inside edge 240f to the back cover inside edge 250f to permit the front cover 240 and back cover 250 to open and close about the hinged connection 232 along a desired spine angle (not shown).

In this embodiment, the removable mirrored portfolio insert 230 further comprises a mirror or mirrored surface 260 attached to the back cover inside face 250a, the mirror 260 having a front reflective surface 260a, a rear surface 260b, a top edge 260c, a bottom edge 260d opposite the top edge 260c, an inside edge 260f and an outside edge 260e opposite the inside edge. The front surface or face 260a of the mirror 260 contains or otherwise projects a reflective mirror finish (of any variety known in the art) and the rear surface 260b of the mirror 260 is mounted to the rear cover inside face 250a using glue, adhesives, double sided adhesive tape, fasteners, hook and loop fasteners, clips, mirror clips, J-shaped mirror clips, picture frame turn buttons, magnetic mounts, hinges or the like. As such, the mirror 260 may be permanently affixed, movably affixed, or removably affixed to the rear cover inside face 250a. If the mirror 260 breaks, it can be replaced. The mirror 260 may be of any desired size and shape. In a preferred embodiment, the mirror 260 covers a substantial portion of the rear cover inside face 250a such as illustrated in FIG. 8B. In another embodiment, the mirror 260 covers all or substantially all of the rear cover inside face 250a. In one embodiment, the mirror 260 is mounted directly to the rear cover inside face 250a much like as illustrated in the embodiment of FIG. 1B. In another embodiment, much like as illustrated in FIG. 1C, the mirror 260 may also be mounted within a recessed area (not shown) of the rear cover inside face 250a to permit the mirror 200 to be mounted flush with the rear cover inside face 250a, or countersunk into the recessed area. When the mirror 200 is mounted within the recessed area, this helps to further protect the mirror and its edges.

As will be appreciated by one having the benefit of the present disclosure, the overall shape of the removable mirrored portfolio insert 230 is shown as a rectangular shape employing a rectangular-shaped mirror. The removable mirrored portfolio insert 230 could have any desired shape, including for example, square, oval or circular and the mirror could have any desired shape, including, for example, square, oval or circular.

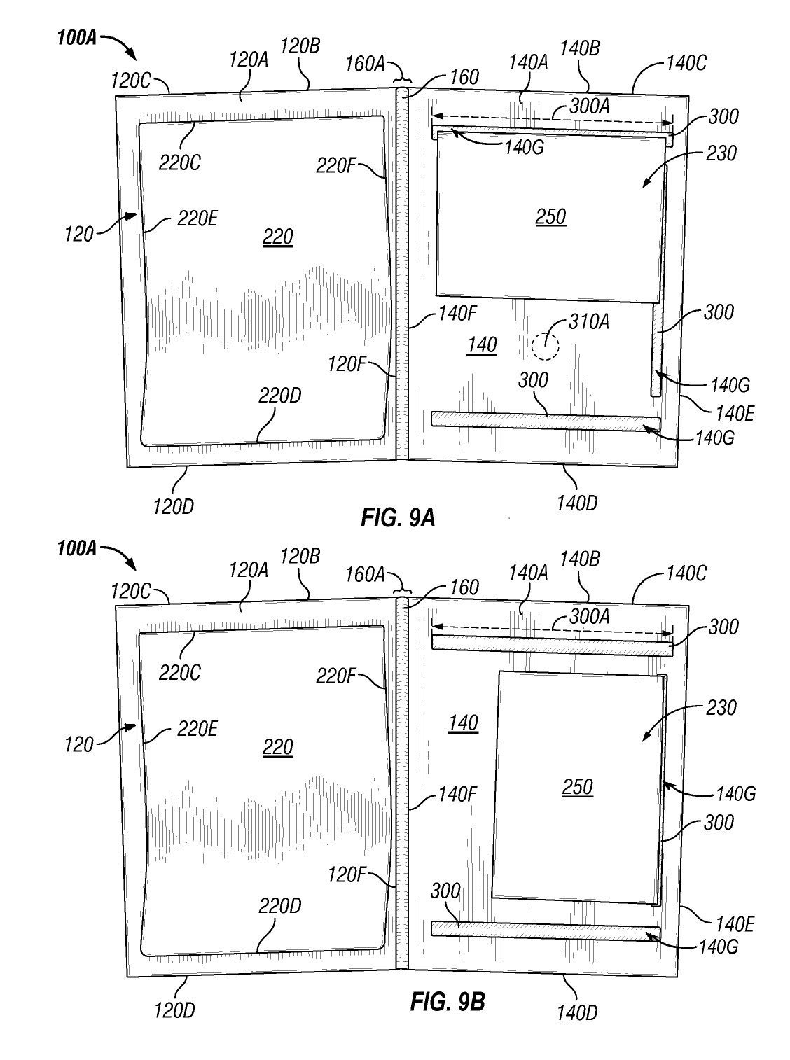

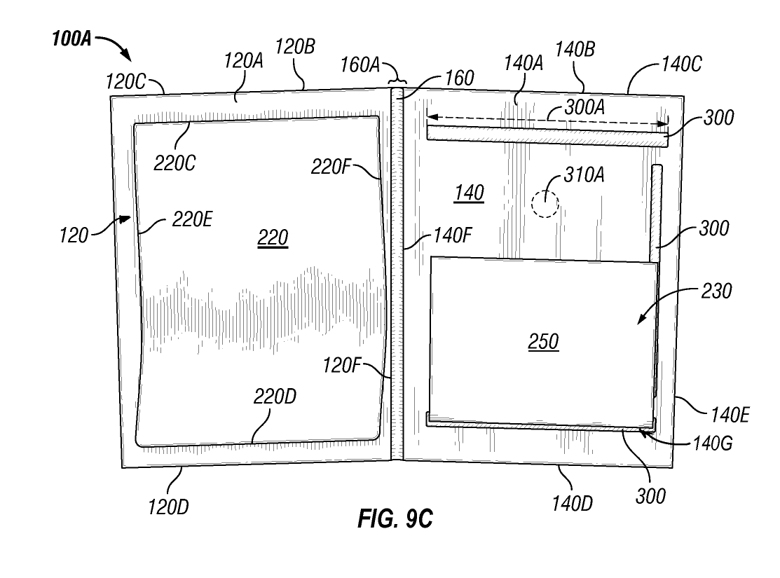

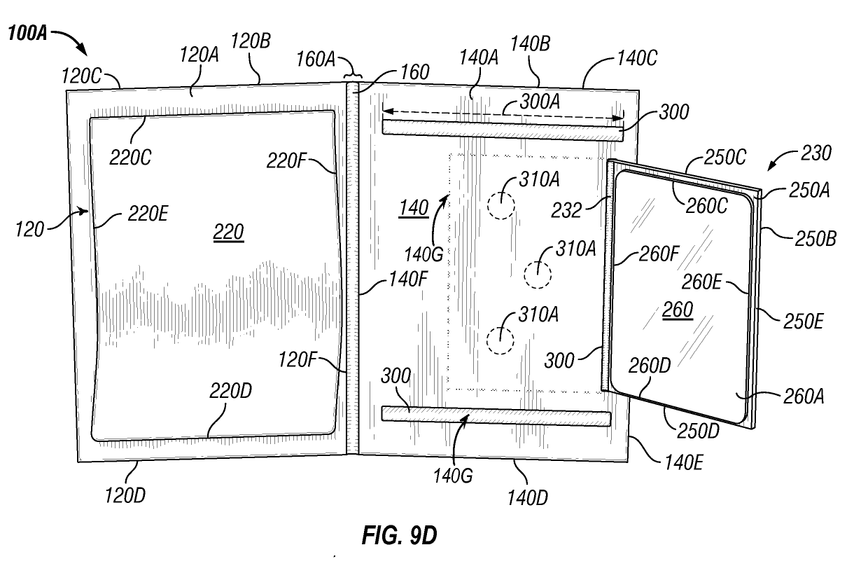

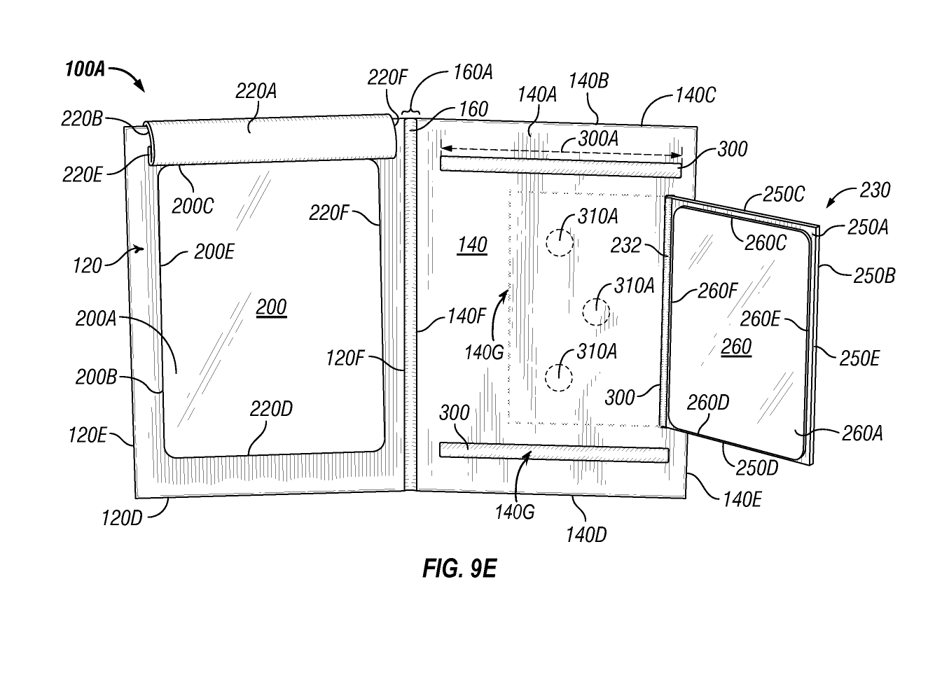

The one or more slits 300 of the practice portfolio 100a, 100b, 100c and 100d are designed to receive the removable mirrored portfolio insert front cover 240 in snug relationship in a space (not shown) between the portfolio back cover inside face 140a and back cover outside face 140b. This is generally illustrated in FIGS. 9A, 9B, 9C, 9D, 12A, 12B, 13A, 13B, 14, and 20. Where only one slot is present, a pocket can be designed and sized, with the slot as its opening, to receive the front cover 240. Where multiple slits 300 are present, such as illustrated in, e.g., FIG. 7A, it will be appreciated that the back cover inside face 140a can be designed as an overlay sheet, with the desired slots cut into it, and then the overlay sheet is attached about its outer edges to the back cover 140 to create a space beneath inside face 140 to permit the front cover 240 to be inserted into the desired slit 300.

In another embodiment, the removable portfolio insert front cover 240 has one or more magnets 310b attached thereto or embedded therein. In this embodiment, the practice portfolios 100a, 100b, 100c and 100d are also outfitted with one or more magnets 310a inserted into or embedded within the back cover 140 oriented or positioned so that the polarity of magnet(s) 310b is attracted to the polarity of magnet(s) 310a. The use of magnets can assist in holding the inserted front cover 240 in place, particularly when the mirrored section is opened for use, such as illustrated in FIG. 9D. The magnets may be of any type, size and arrangement known in the art. In another embodiment, the magnets comprise a flexible magnetic sheet. The use of embedded magnets in the cover of the practice portfolio can also assist in securing the practice portfolio to a metal music stand or other metal surface.

In another embodiment, such as shown in FIGS. 7A, 8A, 8B, 8C, 9A, 9B, 9C, and 9D, the insertable portfolio 230 has a single magnet 310b centrally located within its front cover 240, and the practice portfolios 100a, 100b, 100c and 100d have a corresponding single magnet 310a associated with each slit 300 located within the cover 140 to align with the magnet 310b when the removable portfolio 230 is inserted in the slit. In this orientation, the polarity of the magnets 310a and 310b are oriented so that the magnet 310b in the removable portfolio front cover 240 is magnetically attracted to the corresponding magnet 310a in the practice portfolio back cover 140.

Preferably, where multiple slits 300 are used, each slit has the same slit width 300a. The slit width 300a should be at least the same length as the inside front cover edge height 240e-1. In a preferred embodiment, the practice portfolios 100a, 100b, 100c and 100d contain three slits: one horizontal slit proximate the upper edge 140c, one horizontal slit proximate the lower edge 140d, and one vertical slit proximate the outer edge 140e. The use of multiple slits provides the user with more potential mirror configurations.

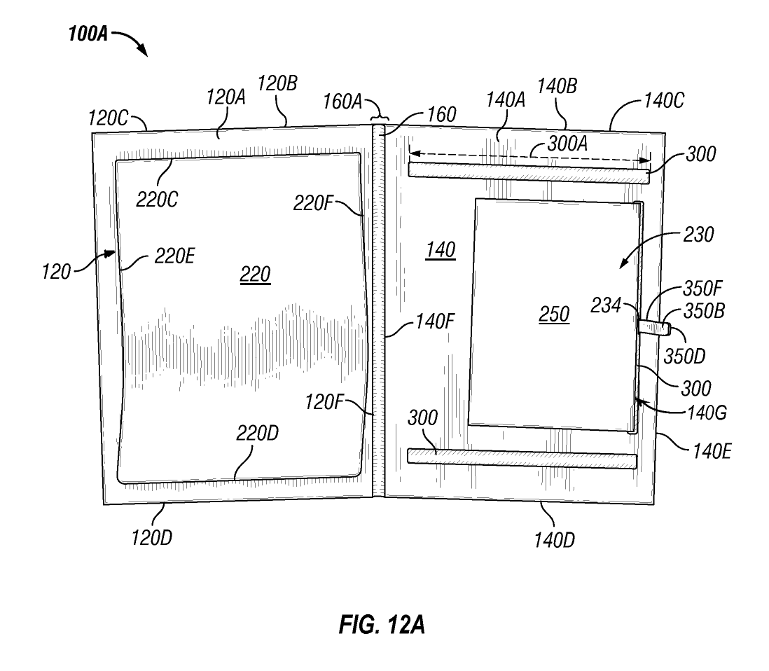

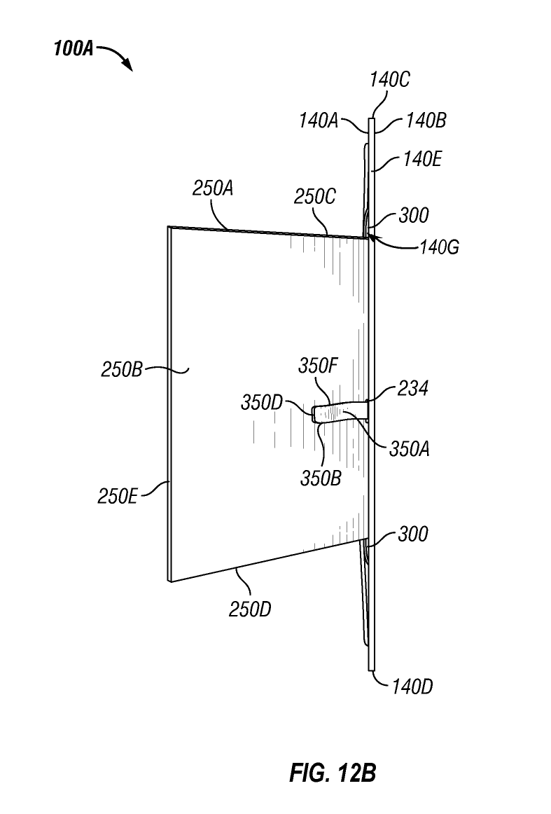

Referring again to FIGS. 8A, 9B, and 8C, in connection with FIGS. 11, 12A and 12B, there is illustrated the use of an insertable clip or brace 350 that may be used, if desired, to assist in adjusting the degree to which the inserted portfolio 230 may be opened when in use. The clip 350 generally comprises a flat material, such as metal or plastic, of narrow width, and having opposed flat ends and a curved, central section forming a somewhat bow-like shape. As illustrated, the clip 350 comprises a first end 350c, a second end 350d, a top surface 350a, bottom surface 350b, and curved segments 350e and 350f. When the inserted portfolio insert 230 is in use, the clip first end 350c is inserted into an opening 234 of width 234a located in the spine 232 (preferably at about the midpoint thereof) of the removable portfolio mirror insert 230 with the clip's bottom surface 350b facing outward as shown in FIG. 12A. The insert 230 can then be opened (as illustrated in FIG. 12B) and the user can then adjust the depth that the clip 350 is inserted into the spine opening 234 to thereby adjust the angle to which the insert 230 is opened.

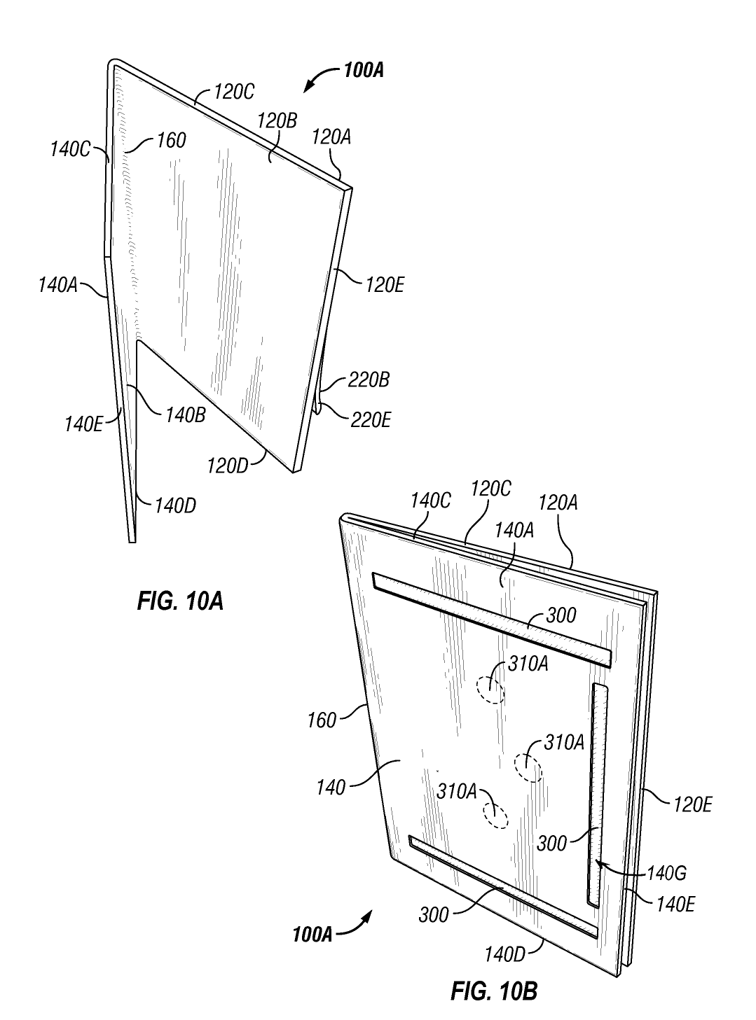

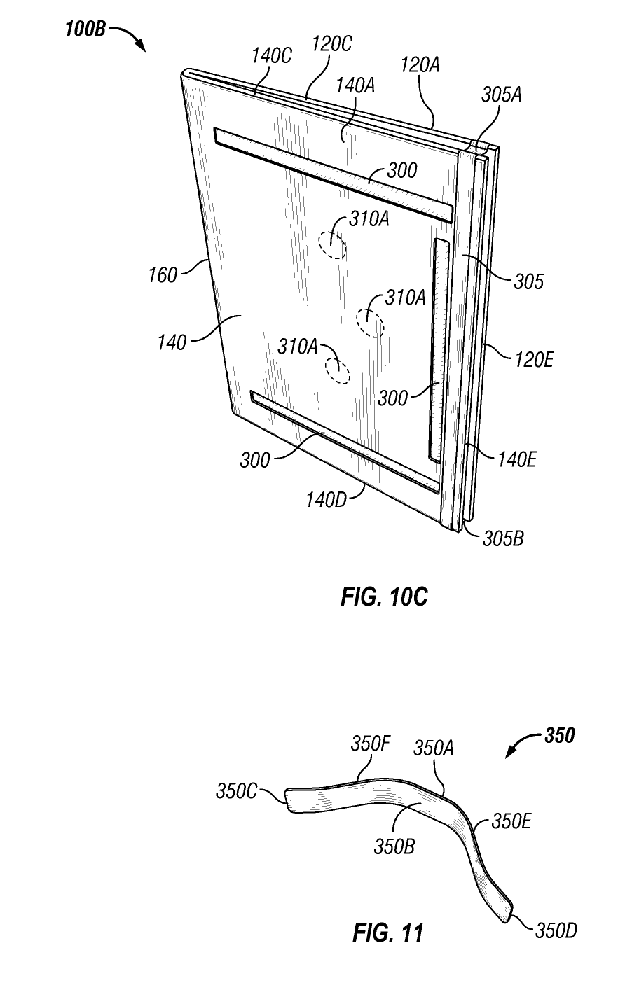

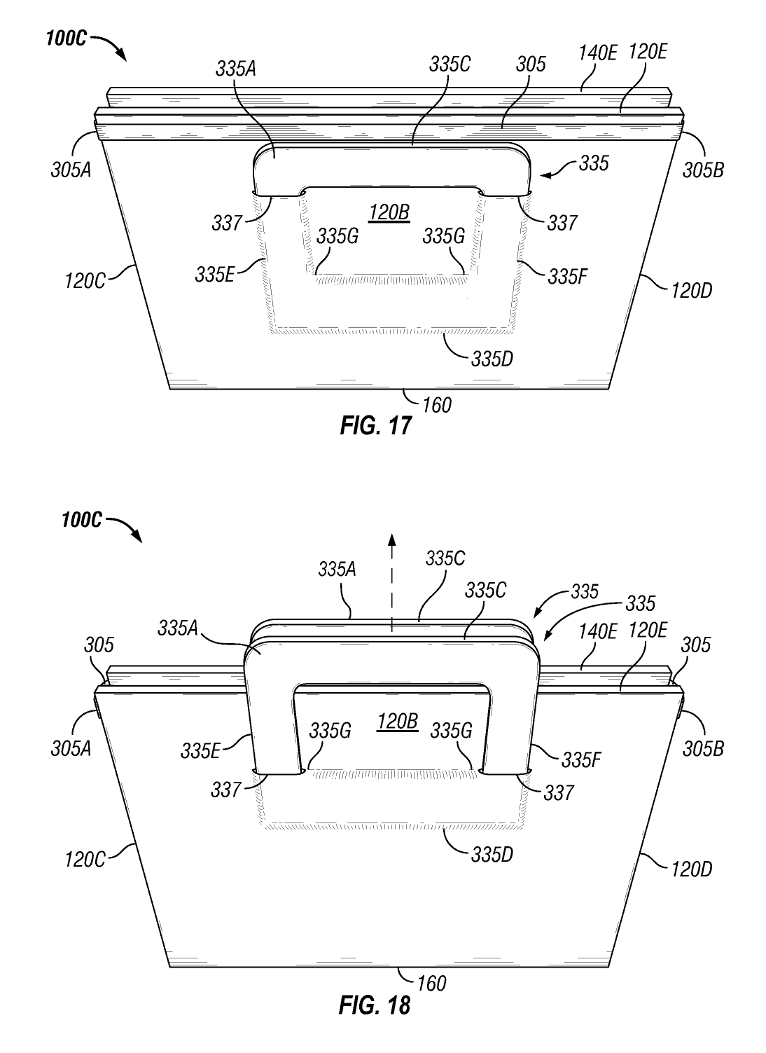

Referring now to FIGS. 10C, 17, 18, 19 and 20 there is illustrated the use of an elastic strap or band 305 (having opposed ends 305a, 305b) that may be employed to maintain the practice portfolio 100B closed when not in use (as shown in FIG. 17), or as shown, to maintain the practice portfolio 100B in a folded back position when desired. Preferably, the band 305 can be fixably attached to the portfolio 100B. Additionally, referring also back to FIGS. 1D and 5E, the elastic band can be employed to attach over a music stand to help secure the portfolio in place when in use with extended mirrors.

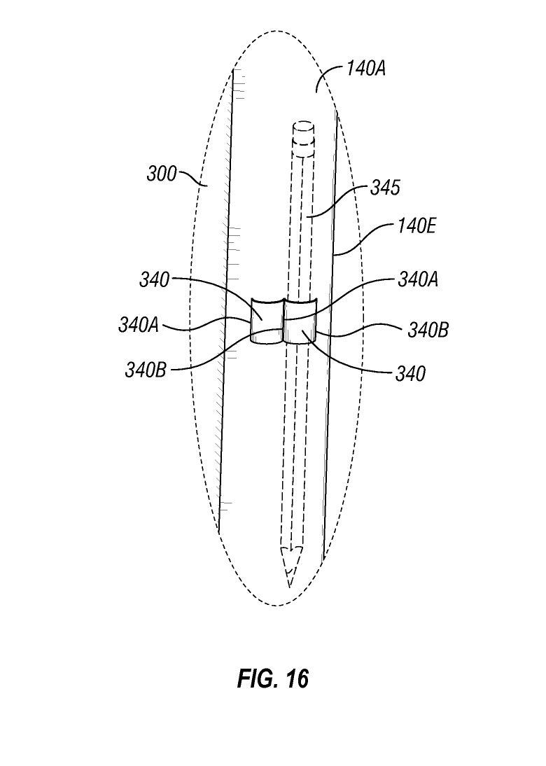

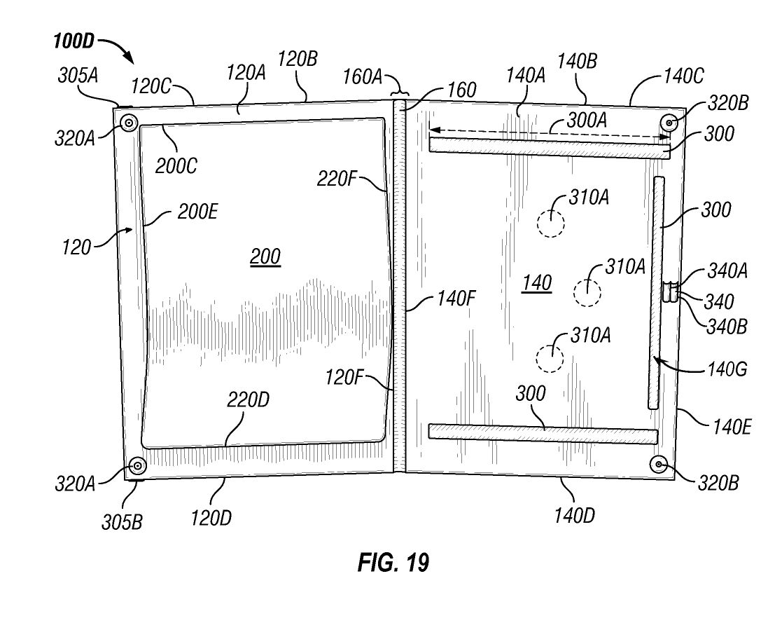

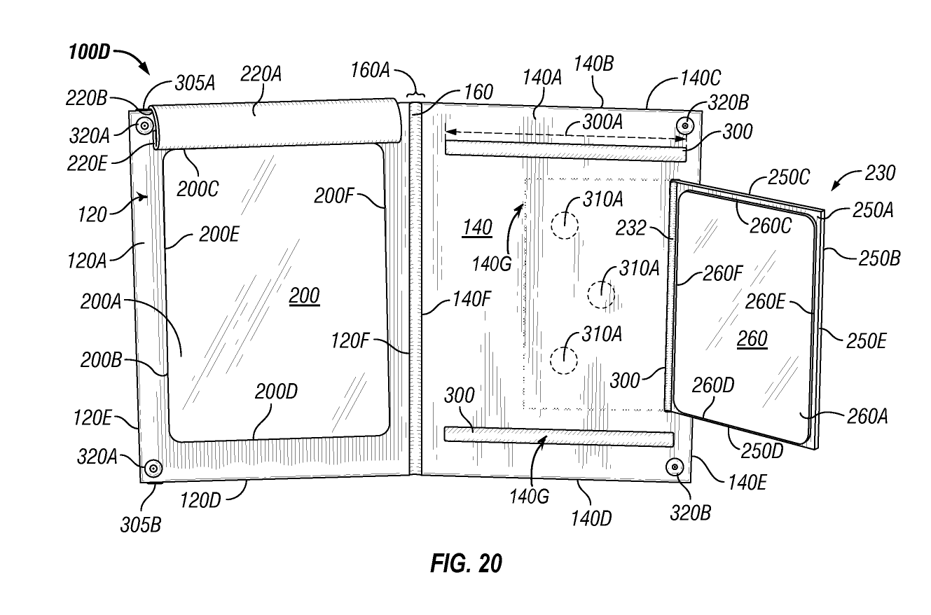

Referring to FIGS. 16 and 19, there is illustrated the use of one or more loops 340 or other fasteners to, e.g., hold pencils 345, pens (not shown) and the like. The loops may be made from any suitable material, including plastic, elastic, and the like. In one embodiment, each loop is a partial loop attached at opposed edges 340a, 340b. The one or more pencil holder loops 340 are fastened to the practice portfolio 100A, 100B, 100C, 100D. In one embodiment, the one or more loops 340 are attached to the inside face 140a between the outer edge 140e and the slit 300. In this embodiment, the user can also use one or more pencils or other objects in the loop(s) 340 to also serve as a stop for purposes of adjusting the angle of the opened portfolio insert 230 (e.g., as shown in FIG. 20).

Referring now to FIGS. 17 and 18, there is depicted a practice portfolio 100C of the variety described herein equipped with external retractable handles 335 installed within the front and rear covers (120, 140) of the portfolio 100C. In this embodiment, each handle comprises an upper horizontal member 335a (having upper edges 335c) located outside of the respective front or back cover 120b, 140b, a lower horizontal member 335d located within a pocket (not shown) within the respective front or back cover 120b, 140b, and two opposed vertical members 335e, 335f connecting the two horizontal members 335a, 335d and extending through cover slots 337. The lower horizontal member 335d has an upper edge 335g that stops within the pocket against the slots 337 to prevent the handle from coming out of the cover when the handle is pulled outward in the direction of the arrow for use (as seen in FIG. 18). When the handle is not in use, the handle top edges 335c are pushed downwardly to retract the handles into a retracted position shown in FIG. 17. The retractable handles depicted here are just exemplary. Other retractable handle designs will be apparent to those having the benefit of the present disclosure.

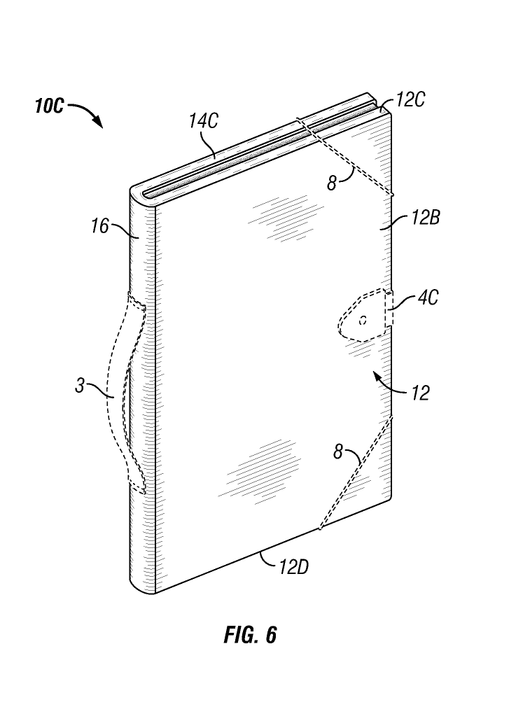

Referring again to FIGS. 19 and 20, in another embodiment of the practice portfolio 100D, snaps or magnetic snaps 320a, 320b may be attached in the inside corners of the portfolio 100D to facilitate closure of the portfolio when not in use. For example, snaps 320a could be magnetic of one polarity, and the receiving snaps 320b could be magnetic of an opposite polarity. In another example, snaps 320a are standard snaps that are received into receiving snaps 320b. In yet another embodiment, magnets could be embedded within the corners of the portfolio (generally in the location of 320a, 320b) to facilitate magnetically maintaining the portfolio in a closed position when desired (such as illustrated in FIGS. 6, 17 and 18) and also in a reversed open position (as shown in FIGS. 10B and 10C).

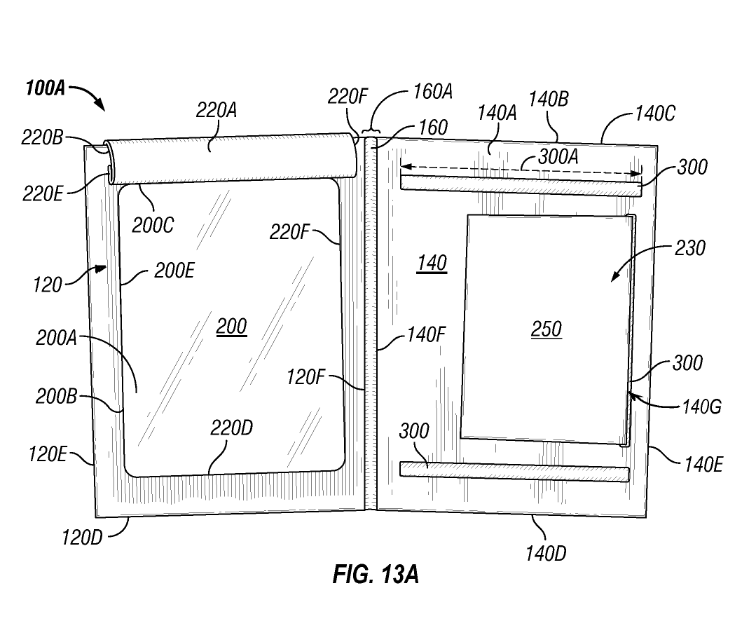

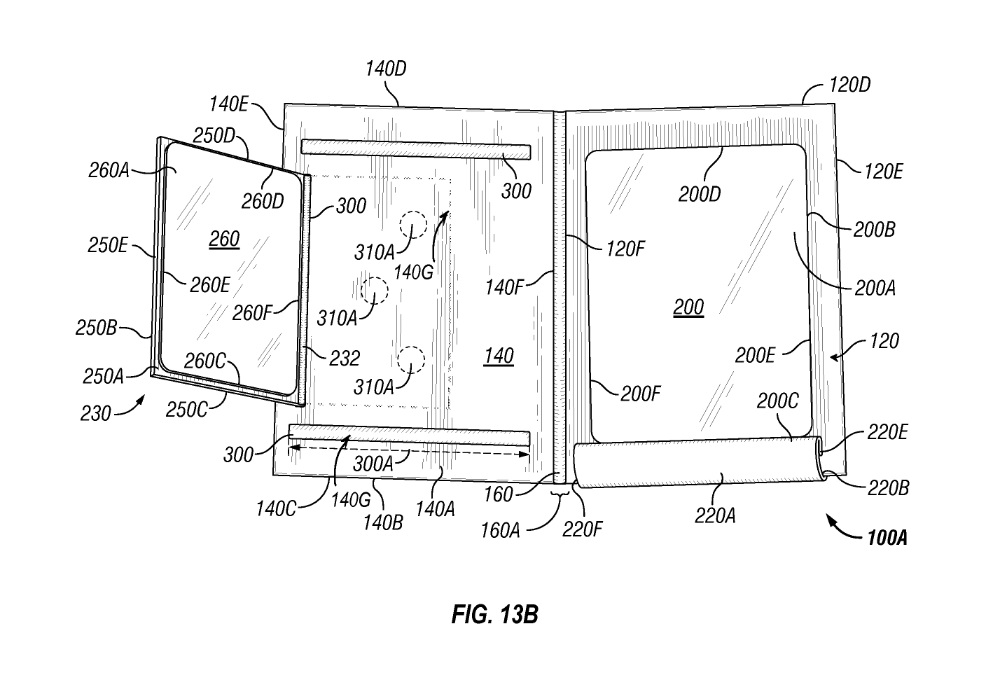

In view of the above disclosure, a versatile mirrored practice portfolio is disclosed. For example, FIG. 9A illustrates the use of a removable portfolio mirror insert 230 mounted in slit 300 located proximate the top edge 140b of the portfolio 100a. This mirror insert 230 is shown in its closed position, but could be opened and used alone (as in FIG. 9D) or in conjunction with the mirror 200 on the opposite side of the portfolio (as in FIG. 9E). Likewise, the mirror 200 can be used while the mirror insert 230 is closed as depicted in FIG. 13. Similarly, as may be desired, the practice portfolio can be flipped over and used so that the mirror insert is on the left side and the mirror 200 is on the right side as illustrated in FIG. 13. A clip device 340 can also be employed to assist in adjusting the angle of opening of the mirror insert 230 as depicted in FIGS. 11, 12A and 12B.

FIG. 9B illustrates the use of a removable portfolio mirror insert 230 mounted in slit 300 located proximate the outer edge 140e of the portfolio 100a. This mirror insert 230 is shown in its closed position, but could be opened and used alone or in conjunction with the mirror 200 on the opposite side of the portfolio. FIG. 9C illustrates the use of a removable portfolio mirror insert 230 mounted in slit 300 located proximate the lower edge 140d of the portfolio 100a. This mirror insert 230 is shown in its closed position, but could be opened and used alone or in conjunction with the mirror 200 on the opposite side of the portfolio.

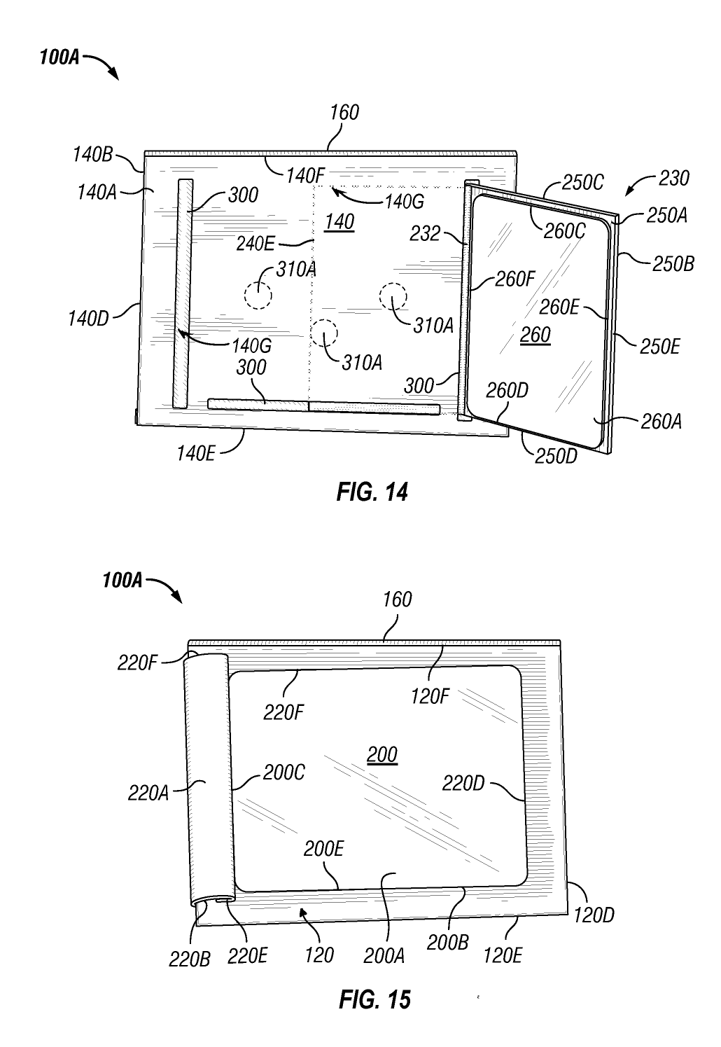

FIGS. 10A, 10B, 10C illustrate how the practice portfolio 100a, 100b, 100c, 100d can be opened all the way so that the outer surfaces of the front and back covers are brought together. The user can the secure the practice portfolio into this folded back configuration using, e.g., the elastic band 305. In its folded back position, the user can choose to use one side or the other as illustrated in FIGS. 14 and 15.

Pencil holders and the like can be mounted in the practice portfolio as described above in connection with FIGS. 16 and 19.

When the practice portfolio is not being used, it can be closed and secured by, e.g., elastic band, snaps, or other closure devices, and can then be carried in hand or in a backpack like a portfolio, or handles can be employed (FIGS. 6, 18) to carry it like a briefcase.

As will be understood by those having the benefit of the present disclosure, the present practice portfolio can also be used in conjunction with sheet music or other written materials, such as a book, that can be clipped to the notebook. Similarly, electronic devices, such as, an iPhone® smart phone or other like device or an iPad® tablet, or the like, can also be suitably attached to the practice notebook, e.g., via one of the slits, while still permitting use of the one or more slits to receive a mirrored portfolio insert. In one such embodiment, the practice portfolio can also serve as a carrying case for such electronic smartphone or electronic tablet device.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention. Further modifications and alternative embodiments of this invention will be apparent to those skilled in the art in view of this specification.

What is claimed is:

1. A portable mirrored practice notebook comprising:
a. a front cover having a front cover inside face, a front cover outside face, a front cover top edge, a front cover bottom edge opposite the front cover top edge, a front cover outside edge, and a front cover inside edge opposite the front cover outside edge;
b. a back cover having a back cover inside face, a back cover outside face, a back cover top edge, a back cover bottom edge opposite the back cover top edge, a back cover outside edge, a back cover inside edge opposite the back cover outside edge;
c. a flexible spine hingedly connecting the front cover inside edge to the back cover inside edge to permit the front cover and back cover to open and close about the hinged connection along a desired spine angle;
d. a first mirror attached to the front cover inside face, the first mirror having a front surface, a rear surface, a top edge, a bottom edge opposite the top edge, an inside edge and an outside edge opposite the inside edge;
e. an internal space behind the back cover inside face;
f. one or more slits, having a desired slit length, in the back cover inside face for accessing the internal space behind the back cover inside face; and
g. a removable mirrored portfolio insert comprising
i. an insert front cover having an insert front cover inside face, an insert front cover outside face, an insert front cover top edge, an insert front cover bottom edge opposite the inset front cover top edge, an insert front cover outside edge, and an insert front cover inside edge opposite the insert front cover outside edge;
ii. an insert back cover having an insert back cover inside face, an insert back cover outside face, an insert back cover top edge, an insert back cover bottom edge opposite the insert back cover top edge, an insert back cover outside edge, and an insert back cover inside edge opposite the insert back cover outside edge;
iii. an insert flexible spine hingedly connecting the insert front cover inside edge to the insert back cover inside edge to permit the insert front cover and insert back cover to open and close about the hinged connection along a desired insert spine angle; and
iv. a mirror or mirrored surface in the insert back cover inside face;
the insert front cover capable of being inserted into the one or more slits in the back cover inside face and into the internal space to removably attach the mirrored portfolio insert to the practice notebook.

2. The notebook of claim 1 wherein the one or more slits comprises a single slit located parallel to and proximate the back cover top edge.

3. The notebook of claim 1 wherein the one or more slits comprises a single slit located parallel to and proximate the back cover bottom edge.

4. The notebook of claim 1 wherein the one or more slits comprises a single slit located parallel to and proximate the back cover outside edge.

5. The notebook of claim 1 wherein the one or more slits comprises a first slit located parallel to and proximate the back cover top edge, a second slit located parallel to and proximate the back cover bottom edge, and a third slit located parallel to and proximate the back cover outside edge.

6. The notebook of claim 1 further comprising one or more first magnets embedded within the back cover, the first magnets having a first polarity directed toward the back cover inside face, and one or more second magnets embedded within the insert front cover, the second magnets oriented to direct a second polarity opposite the first polarity to cause the one or more second magnets to be attracted to the one or more first magnets when the insert front cover is inserted into the internal space through one of the one or more slits.

7. The notebook of claim 1 further comprising a flexible protective material for covering the first mirror, the flexible material having a top edge, bottom edge, right side edge and left side edge, the flexible material being attached to the front cover inside face and attached independent from the flexible spine and oriented perpendicular relative to the flexible spine to permit the protective material to cover the mirror when the mirror is not in use and to be pulled back to expose the mirror when the mirror is to be used, wherein the flexible protective material is selected from the group consisting of: synthetic cloth, natural cloth, flannel cloth, synthetic and natural cloth blends, soft suede-like material, plastic sheet material, and rubber sheet material.

8. The notebook of claim 1 further comprising a removable insertable clip capable of being inserted into and removed from the insert flexible spine to assist in maintaining a desired angle of openness between the insert front and back faces when in use in the notebook, the insert flexible spine further comprising an opening for receiving the clip.

9. The notebook of claim 1 further comprising one or more loops attached to the notebook for holding pencils or pens.

10. The notebook of claim 1 further comprising a closure device for securing the notebook front cover to the notebook back cover.

11. A portable mirrored practice notebook comprising:
a. a front cover having a front cover inside face, a front cover outside face, a front cover top edge, a front cover bottom edge opposite the front cover top edge, a front cover outside edge, and a front cover inside edge opposite the front cover outside edge;
b. a back cover having a back cover inside face, a back cover outside face, a back cover top edge, a back cover bottom edge opposite the back cover top edge, a back cover outside edge, a back cover inside edge opposite the back cover outside edge;
c. a flexible spine hingedly connecting the front cover inside edge to the back cover inside edge to permit the front cover and back cover to open and close about the hinged connection along a desired spine angle;
d. a first mirror attached to the front cover inside face, the first mirror having a front surface, a rear surface, a top edge, a bottom edge opposite the top edge, an inside edge and an outside edge opposite the inside edge;
e. an internal space behind the back cover inside face;
f. one or more slits, having a desired slit length, in the back cover inside face for accessing the internal space behind the back cover inside face; and
g. a removable mirrored portfolio insert comprising
i. an insert front cover having an insert front cover inside face, an insert front cover outside face, an insert front cover top edge, an insert front cover bottom edge opposite the inset front cover top edge, an insert front cover outside edge, and an insert front cover inside edge opposite the insert front cover outside edge;
ii. an insert back cover having an insert back cover inside face, an insert back cover outside face, an insert back cover top edge, an insert back cover bottom edge opposite the insert back cover top edge, an insert back cover outside edge, and an insert back cover inside edge opposite the insert back cover outside edge;
iii. an insert flexible spine hingedly connecting the insert front cover inside edge to the insert back cover inside edge to permit the insert front cover and insert back cover to open and close about the hinged connection along a desired insert spine angle; and
iv. a mirror or mirrored surface in the insert back cover inside face;
the insert front cover capable of being inserted into the one or more slits in the back cover inside face and into the internal space to removably attach the mirrored portfolio insert to the practice notebook; and
h. one or more first magnets embedded within the back cover, the first magnets having a first polarity directed toward the back cover inside face, and one or more second magnets embedded within the insert front cover, the second magnets oriented to direct a second polarity opposite the first polarity to cause the one or more second magnets to be attracted to the one or more first magnets when the insert front cover is inserted into the internal space through one of the one or more slits.

12. The notebook of claim 11 wherein the one or more slits comprises a first slit located parallel to and proximate the back cover top edge, a second slit located parallel to and proximate the back cover bottom edge, and a third slit located parallel to and proximate the back cover outside edge.

13. The notebook of claim 11 further comprising a flexible protective material for covering the first mirror, the flexible material having a top edge, bottom edge, right side edge and left side edge, the flexible material being attached to the front cover inside face and attached independent from the flexible spine and oriented perpendicular relative to the flexible spine to permit the protective material to cover the mirror when the mirror is not in use and to be pulled back to expose the mirror when the mirror is to be used, wherein the flexible protective material is selected from the group consisting of: synthetic cloth, natural cloth, flannel cloth, synthetic and natural cloth blends, soft suede-like material, plastic sheet material, and rubber sheet material.

14. The notebook of claim 11 further comprising a removable insertable clip capable of being inserted into and removed from the insert flexible spine to assist in maintaining a desired angle of openness between the insert front and back faces when in use in the notebook, the insert flexible spine further comprising an opening for receiving the clip.

15. The notebook of claim 11 further comprising one or more loops attached to the notebook for holding pencils or pens.

16. The notebook of claim 11 further comprising a closure device for securing the notebook front cover to the notebook back cover.

17. The notebook of claim 12 further comprising a flexible protective material for covering the first mirror, the flexible material having a top edge, bottom edge, right side edge and left side edge, the flexible material being attached to the front cover inside face and attached independent from the flexible spine and oriented perpendicular relative to the flexible spine to permit the protective material to cover the mirror when the mirror is not in use and to be pulled back to expose the mirror when the mirror is to be used, wherein the flexible protective material is selected from the group consisting of: synthetic cloth, natural cloth, flannel cloth, synthetic and natural cloth blends, soft suede-like material, plastic sheet material, and rubber sheet material.

18. The notebook of claim 17 further comprising a removable insertable clip capable of being inserted into and removed from the insert flexible spine to assist in maintaining a desired angle of openness between the insert front and back faces when in use in the notebook, the insert flexible spine further comprising an opening for receiving the clip; and a closure device for securing the notebook front cover to the notebook back cover.

19. The notebook of claim 18 further comprising one or more loops attached to the notebook for holding pencils or pens.
